(19) United States
(12) Patent Application Publication
(10) Pub. No.: US 2014/0037226 A1
(43) Pub. Date: Feb. 6, 2014

(54) IMAGE PROCESSING DEVICE, DISPLAY DEVICE, IMAGE PROCESSING METHOD

(71) Applicants: Yoshimitsu Murahashi, Osaka-shi (JP); Seiichi Gohshi, Osaka-shi (JP); Takaji Numao, Osaka-shi (JP)

(72) Inventors: Yoshimitsu Murahashi, Osaka-shi (JP); Seiichi Gohshi, Osaka-shi (JP); Takaji Numao, Osaka-shi (JP)

(73) Assignee: SHARP KABUSHIKI KAISHA, Osaka-shi, Osaka (JP)

(21) Appl. No.: 14/113,406

(22) PCT Filed: Apr. 26, 2012
(86) PCT No.: PCT/JP12/61273

§ 371 Date: Oct. 23, 2013

(30) Foreign Application Priority Data
Apr. 27, 2011 (JP) 2011-100157

(51) Int. Cl. G06T 5/00

(52) U.S. Cl. CPC G06T 5/003
USPC 382/263; 382/275

(57) ABSTRACT

An image processing device includes a signal supplementing unit that generates a harmonic signal of a signal of a predetermined frequency band in an image signal, and supplements the image signal with the generated harmonic signal.

### TECHNICAL FIELD

The present invention relates to an image processing device, a display device, and an image processing method.

This application is based upon and claims the benefit of priority from Japanese Patent Application No. 2011-100157, filed Apr. 27, 2011, the entire contents of which are incorporated herein by reference.

### BACKGROUND ART

When a video is captured in real time from an image input apparatus (for example, a television imaging apparatus), and the captured video is transmitted as a video signal so as to be displayed on a receiver apparatus, a noise component is mixed into a signal in a transmission path, and a noise component is also mixed into a signal in the receiver. For example, in an analog television broadcast, a noise component is markedly mixed into a video signal when a signal level of the received video signal is low. In addition, this is also the same for a case where a recorded analog video is digitalized and is rebroadcast via a transmission path, and a noise component is markedly mixed into the video signal.

PTL 1 discloses a noise reducing circuit which subtracts or adds a smoothing value of a noise component in a vertical blanking period from or to an input signal by using a magnitude relationship between an input video signal and an output of a median filter, thereby reducing a noise component which remains in a band.

### CITATION LIST

### Patent Literature

PTL 1: Japanese Unexamined Patent Application Publication No. 7-250264
PTL 2: Japanese Unexamined Patent Application Publication No. 2010-198599

### DISCLOSURE OF INVENTION

### Problems to be Solved by the Invention

However, if a noise reduction process is performed on a weak video signal, there is a problem in that definition tends to be removed from an original image since the noise reduction strongly acts thereon. In addition, there is a problem in that, since a scale conversion (hereinafter, referred to as an “up-scaling process”) to an image with the number of pixels larger than the number of pixels of an image from which noise is reduced is performed, the image which appears blurred as a whole is displayed.

On the other hand, in the related art, a method of removing a blur of an image has been proposed (for example, refer to PTL 2). However, in an image processing method of PTL 2, a plurality of low resolution images with a low spatial resolution are combined so as to generate a reference image. For this reason, there is a problem in that a signal with a frequency band which is equal to or more than a spatial frequency of an original image cannot be generated, and thus a defined image cannot be obtained.

The present invention has been made in consideration of the above-described problems, and an object thereof is to provide a technique of enabling a defined image to be generated.

### Means for Solving the Problems

(1) The present invention has been made in light of the above-described circumstances, and an image processing device according to a first aspect of the present invention includes a signal supplementing unit that generates a harmonic signal of a signal of a predetermined frequency band in an image signal, and supplements the image signal with the generated harmonic signal.

(2) In addition, in the first aspect, the signal supplementing unit may perform nonlinear mapping on the signal with the predetermined frequency band so as to generate the harmonic signal.

(3) Further, in the first aspect, the nonlinear mapping may be odd function mapping.

(4) In addition, in the first aspect, the predetermined frequency band may be a frequency higher than a predetermined frequency in the image signal.

(5) Further, in the first aspect, the signal supplementing unit may include a supplementary signal generating section that performs nonlinear mapping on the signal with the predetermined frequency band in the image signal; and an adder that adds a signal obtained by the supplementary signal generating section performing the nonlinear mapping to the image signal.

(6) In addition, in the first aspect, the supplementary signal generating section may include a filter that applies a linear filter to the image signal; and a nonlinear operator that performs nonlinear mapping on a signal obtained by the filter applying the linear filter, and the adder may add a signal obtained by the nonlinear operator performing the nonlinear mapping to the image signal.

(7) Further, in the first aspect, the filter may include a vertical high-pass filter that makes a frequency component higher than a predetermined frequency in a vertical direction pass therethrough with respect to the image signal; and a horizontal high-pass filter that makes a frequency component higher than a predetermined frequency in a horizontal direction pass therethrough with respect to the image signal, the nonlinear operator may generate a signal which is obtained by performing nonlinear mapping on the signal having passed through the vertical high-pass filter and supplements the image signal with a vertical high frequency component, and generate a signal which is obtained by performing a nonlinear mapping on the signal having passed through the horizontal high-pass filter and which supplements the image signal with a horizontal high frequency component, and the adder may add the signal which supplements the image signal with the vertical high frequency component and the signal which supplements the horizontal high frequency component.

(8) In addition, in the first aspect, the filter may include a two-dimensional high-pass filter that makes a frequency component higher than a predetermined frequency in a two-dimensional direction pass therethrough with respect to the image signal, the nonlinear operator may perform nonlinear mapping on the signal having passed through the two-dimensional high-pass filter, and the adder may add a signal obtained by the nonlinear operator performing the nonlinear mapping to the image signal.

(9) Further, in the first aspect, the image processing device may further include a scaler unit that performs scale conversion on the image signal to obtain an image with a number of pixels larger than the number of pixels obtained from the image signal, and the signal supplementing unit may generate a harmonic signal of a signal with a predetermined frequency band in an image signal which has been scale-converted by the scaler unit, and supplement the scale-converted image signal with the generated harmonic signal.

(10) In addition, in the first aspect, the image processing device may further include a noise reducing unit that reduces noise of the image signal, and the signal supplementing unit may generate a harmonic signal of a signal with a predetermined frequency band in an image signal from which noise has been reduced by the noise reducing unit, and supplement the noise-reduced image signal with the generated harmonic signal.

(11) A display device according to a second aspect of the present invention includes an image processing device including a signal supplementing unit that generates a harmonic signal of a signal of a predetermined frequency band in an image signal, and supplements the image signal with the generated harmonic signal.

(12) An image processing method according to a third aspect of the present invention includes generating a harmonic signal of a signal of a predetermined frequency band in an image signal, and supplementing the image signal with the generated harmonic signal.

(13) An image processing program according to the third aspect of the present invention causes a computer to execute a step of generating a harmonic signal of a signal of a predetermined frequency band in an image signal, and supplementing the image signal with the generated harmonic signal.

### Effects of the Invention

According to the present invention, it is possible to generate a defined image.

### BRIEF DESCRIPTION OF THE DRAWINGS

FIG. 1 is a schematic block diagram of a liquid crystal display device according to a first embodiment.

FIG. 2 is a diagram illustrating a signal connection relationship between a liquid crystal driving unit 15 and a liquid crystal panel 16.

FIG. 3 is a schematic block diagram of an image processing unit 20 according to the first embodiment.

FIG. 4A is a first diagram illustrating an outline of processes performed by a noise reducing section 21 and a scaler section 22.

FIG. 4B is a second diagram illustrating an outline of processes performed by the noise reducing section 21 and the scaler section 22.

FIG. 4C is a third diagram illustrating an outline of processes performed by the noise reducing section 21 and the scaler section 22.

FIG. 4D is a fourth diagram illustrating an outline of processes performed by the noise reducing section 21 and the scaler section 22.

FIG. 5 is a diagram illustrating a process performed by a signal supplementing section 23.

FIG. 6 is a schematic block diagram of the noise reducing section.

FIG. 7A is a first diagram illustrating a process performed by the signal supplementing section.

FIG. 7B is a second diagram illustrating a process performed by the signal supplementing section.

FIG. 8 is a schematic block diagram of a supplementary signal generator.

FIG. 9 is a diagram illustrating an example in which waveforms output from the adder 24 are compared with each other when a signal passes through nonlinear functions of an even function and an odd function in a nonlinear operator.

FIG. 10 is a functional block diagram of a confirmation device for confirming effects by the signal supplementing section.

FIG. 11A is a diagram illustrating image data A output from the confirmation device of FIG. 10 as an image.

FIG. 11B is a diagram illustrating image data B output from the confirmation device of FIG. 10 as an image.

FIG. 11C is a diagram illustrating image data C output from the confirmation device of FIG. 10 as an image.

FIG. 11D is a diagram illustrating image data D output from the confirmation device of FIG. 10 as an image.

FIG. 12 is a diagram illustrating a distribution of a signal intensity of a frequency domain of each image of FIGS. 11A to 11D.

FIG. 13 is a diagram illustrating a spectral difference obtained by subtracting a spectrum of an image to which noise is added from a spectrum of an image having undergone a noise reduction process.

FIG. 14 is a flowchart illustrating a flow of the processes performed by a display device 1 according to the first embodiment.

FIG. 15 is a flowchart illustrating a flow of the processes performed by the image processing unit in step S102 of FIG. 14.

FIG. 16 is a schematic block diagram of a liquid crystal display device according to a second embodiment.

FIG. 17 is a schematic block diagram of an image processing unit according to the second embodiment.

FIG. 18 is a functional block diagram of a supplementary signal generator according to the second embodiment.

FIG. 19 is a diagram illustrating an example of a functional block diagram of a vertical high-pass filter according to the second embodiment.

FIG. 20 is a functional block diagram of a horizontal low-pass filter according to the second embodiment.

FIG. 21 is a table illustrating an example of setting filter coefficients when seven lines are delayed in a vertical direction or seven pixels are delayed in a horizontal direction.

FIG. 22 is a functional block diagram of a first nonlinear operator according to the second embodiment.

FIG. 23 is a diagram illustrating an example of a signal intensity distribution of an output signal which is output from the first nonlinear operator.

FIG. 24 is a flowchart illustrating a flow of the processes performed by an image processing unit 20b according to the second embodiment in step S102 of FIG. 14.

FIG. 25 is a block configuration diagram of a first nonlinear operator 170b according to a modification example of the second embodiment.

FIG. 26 is a diagram illustrating an example of a table stored in a nonlinear data storage part according to a modification example of the second embodiment.

FIG. 27 is a schematic block diagram of a display device according to a third embodiment.

FIG. 28 is a schematic block diagram of an image processing unit according to the third embodiment.

FIG. 29 is a functional block diagram of a supplementary signal generator according to the third embodiment.

FIG. 30 is a functional block diagram of a two-dimensional high-pass filter 250 according to the third embodiment.

FIG. 31 is a flowchart illustrating a flow of the processes performed by the image processing unit according to the third embodiment in step S102 of FIG. 14.

### BEST MODE FOR CARRYING OUT THE INVENTION

Hereinafter, embodiments of the present invention will be described in detail with reference to the drawings.

### First Embodiment

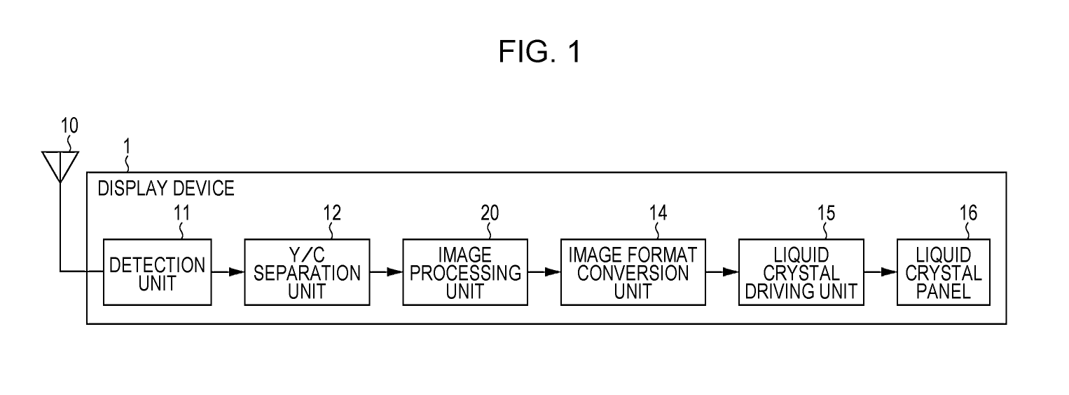

FIG. 1 is a schematic block diagram of a display device 1 according to the first embodiment.

In FIG. 1, the display device 1 includes a detection unit 11, a Y/C (a luminance signal/color difference signal) separation unit 12, an image processing unit 20, an RGB (Red, Green, and Blue) conversion unit 14, a liquid crystal driving unit 15, and a liquid crystal panel 16. In addition, the display device 1 is connected to an antenna 10.

The detection unit 11 receives, for example, high frequency signals of image data of a plurality of channels of a terrestrial analog television broadcast supplied from the external antenna 10. In addition, the detection unit 11 extracts a modulation signal of a desired channel from the high frequency signals supplied from the antenna, and converts the extracted modulation signal into a signal of a baseband so as to be output to the Y/C separation unit 12.

The Y/C separation unit 12 demodulates the supplied signal of a baseband so as to be separated into a luminance signal Y, a color difference signal Cb, and a color difference signal Cr, and converts each of the separated signals into a digital signal at a predetermined sampling frequency.

In addition, the Y/C separation unit 12 outputs image data including luminance data Y, color difference data Cb, and color difference data Cr which have been converted into digital signals, to the image processing unit 20.

Next, an outline of processes performed by the image processing unit 20 will be described. The image processing unit 20 compares each of the supplied luminance data Y, color difference data Cb and color difference data Cr between pixels in the same frame (a pixel space where the pixels are arranged), and determines whether or not noise is superimposed on a processing target pixel.

In addition, the image processing unit 20 calculates a noise level in the frame unit or the field unit. The image processing unit 20 adds or subtracts a noise level which is estimated from a blanking section to or from a processing target pixel on which noise is determined as being superimposed, so as to perform a noise reduction process on a target pixel which is a noise reduction target.

The image processing unit 20 scales up each of the luminance signal Y, the color difference signal Cb, and the color difference signal Cr having undergone the noise reduction process so as to become a predetermined resolution. In addition, the image processing unit 20 applies a nonlinear filter to each of the scaled-up luminance signal Y, color difference signal Cb and color difference signal Cr. Further, the image processing unit 20 outputs an image signal including the luminance signal Y, the color difference signal Cb, and the color difference signal Cr to which the nonlinear filter has been applied, to the image format conversion unit 14.

Details of a process for each pixel in the image processing unit 20 will be described later. Here, in a case where a video signal is interlaced, a noise process is performed for each field. On the other hand, in a case where the video signal is non-interlaced, a noise process is performed for each frame.

The image format conversion unit 14 converts the image signal supplied from the image processing unit 20 into a progressive signal if the image signal is an interlaced signal. In addition, the image format conversion unit 14 adjusts (scaling process) the number of pixels so as to be suitable for a resolution of the liquid crystal panel 16 with respect to the progressive signal.

Further, the image format conversion unit 14 converts the video signal of which the number of pixels has been adjusted into an RGB signal (a color video signal of red, green, and blue), and outputs the converted RGB signal to the liquid crystal driving unit 15.

The liquid crystal driving unit 15 generates a clock signal and the like for displaying video data which is supplied to the liquid crystal panel 16 on a two-dimensional plane of a screen. In addition, the liquid crystal driving unit 15 supplies the generated clock signal and the like to the liquid crystal panel 16.

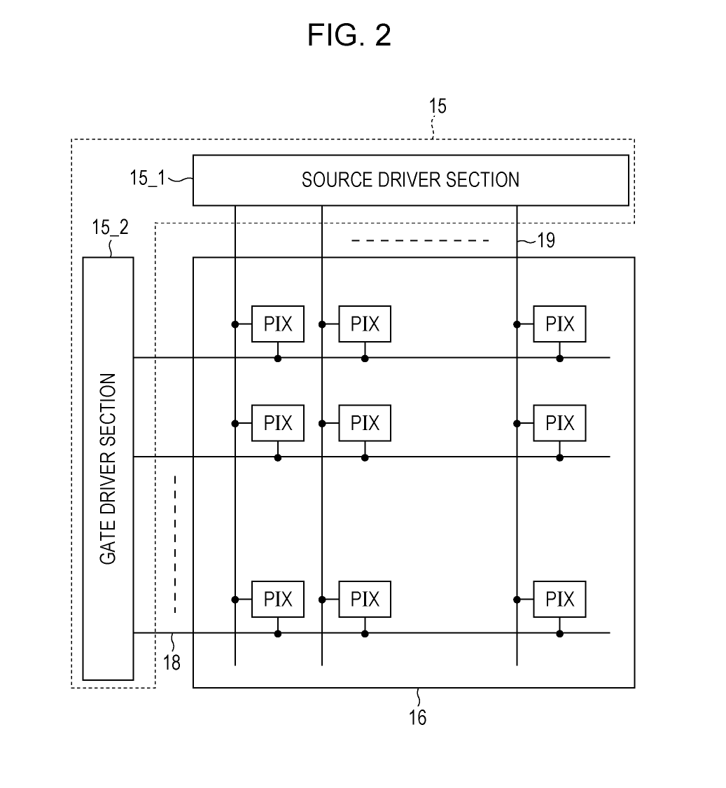

FIG. 2 is a diagram illustrating a signal connection relationship between the liquid crystal driving unit 15 and the liquid crystal panel 16.

As shown in FIG. 2, the liquid crystal driving unit 15 includes a source driver section 15_1 and a gate driver section 15_2. The liquid crystal driving unit 15 controls display elements (liquid crystal elements) PIX which are disposed at intersections of source lines 19 and gate lines 18 in the liquid crystal panel 16, that is, the liquid crystal elements PIX arranged in a matrix, so as to display an image. This liquid crystal element PIX includes a thin film transistor (TFT) and a pixel element of a liquid crystal at a location to which a voltage corresponding to a grayscale described later is written (a voltage is applied) via the TFT.

The source driver section 15_1 generates a voltage which corresponds to a grayscale for driving the pixel element from the supplied RGB signal. The source driver section 15_1 holds the grayscale voltage (a source signal which is information regarding a grayscale) in a hold circuit installed therein for each of the source lines 19 (wires in a column direction) of the liquid crystal panel 16.

In addition, the source driver section 15_1 supplies the source signal to the source lines 19 of the TFTs in the liquid crystal elements PIX of the liquid crystal panel 16 in synchronization with the clock signal with respect to the arrangement in the longitudinal direction of the screen.

The gate driver section 15_2 supplies a predetermined gate signal to the liquid crystal elements PIX of one row of the screen via the gate line 18 (a wire in the transverse direction, corresponding to main scanning) of the TFTs in the liquid crystal elements PIX of the liquid crystal panel 16 in synchronization with the clock signal.

The liquid crystal panel 16 includes an array substrate, a counter substrate, and a liquid crystal sealed therebetween. The liquid crystal element PIX, that is, a pair of pixel elements including the TFT, a pixel electrode connected to a drain electrode of the TFT, and a counter electrode (formed of a strip electrode on the counter substrate) is disposed for each intersection of the source line 19 and the gate line 18 on the array substrate. In the pixel element, the liquid crystal is sealed between the pixel electrode and the counter electrode. In addition, the liquid crystal panel 16 has three subpixels corresponding to three primary colors RGB (red, green, and blue) for each pixel, that is, for each liquid crystal element PIX. Further, the liquid crystal panel 16 has a single TFT for each subpixel.

When a gate signal supplied from the gate driver section is supplied to a gate electrode, and the gate signal is, for example, at a high level, the TFT is selected and is turned on. A source signal supplied from the source driver section is supplied to a source electrode of the TFT, and, when the TFT is turned on, a grayscale voltage is applied to the pixel electrode connected to the drain electrode of the TFT, that is, the pixel element.

The alignment of the liquid crystal of the pixel element varies according to the grayscale voltage, and thus the light transmittance of the liquid crystal in a region of the pixel element varies. The grayscale voltage is stored in a liquid crystal capacitor (forming a hold circuit) of the pixel element formed by a liquid crystal portion between the pixel electrode connected to the drain electrode of the TFT and the counter electrode, and thus the alignment of the liquid crystal is maintained. The alignment of the liquid crystal is maintained by the grayscale voltage until the next signal is supplied to the source electrode and thus the stored voltage value is changed, and thus the light transmittance of the liquid crystal is maintained during that time.

In the above-described way, the liquid crystal panel 16 displays supplied video data by using grayscales.

In addition, a transmissive liquid crystal panel has been described here, but the present invention is not limited thereto, and a reflective liquid crystal panel may be used.

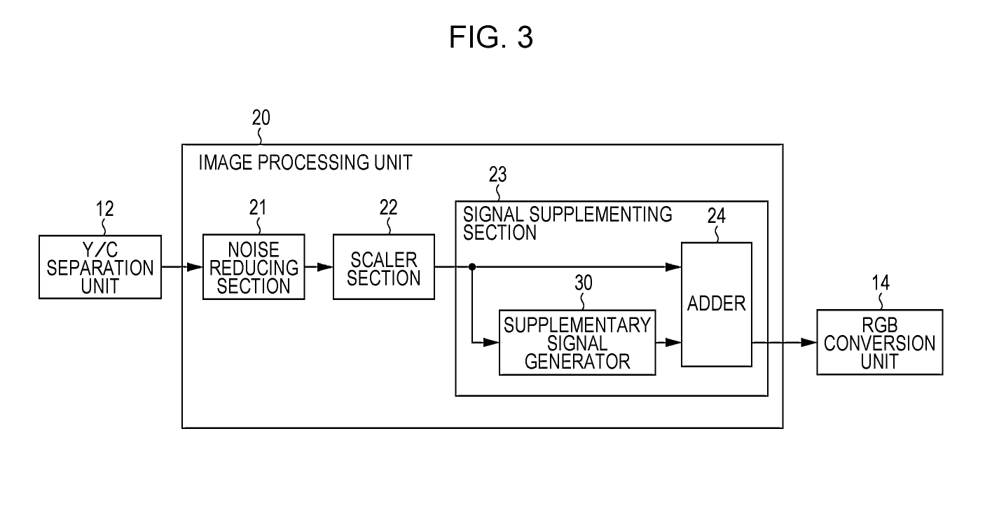

FIG. 3 is a schematic block diagram of the image processing unit 20 according to the first embodiment. The image processing unit 20 includes a noise reducing section 21, a scaler section 22, and a signal supplementing section 23.

The noise reducing section 21 receives image data in which a raster-scanned image signal is sent by one sample, from the Y/C separation unit 12, and reduces noise of the image data. The noise reducing section 21 outputs the image data from which noise has been removed to the scaler section 22. Details of a process performed by the noise reducing section 21 will be described later.

The scaler section 22 interpolates an image having a number of pixels larger than the number of pixels obtained from the image data from which noise is reduced by the noise reducing section 21. This interpolation is performed by interpolating a pixel of 0 in an interval between samples in which a pixel value is present. In addition, the scaler section 22 performs filtering on the interpolated image data by using a low-pass filter having a predetermined cutoff frequency. The scaler section 22 outputs the filtered data to the signal supplementing section 23 as scale-converted image data.

The signal supplementing section 23 supplements the scale-converted image data with data in which mapping has been performed on a signal with a predetermined frequency band in the scale-converted image data. Here, the signal supplementing section 23 includes a supplementary signal generator 30 and an adder 24.

The supplementary signal generator 30 generates harmonic signals (for example, odd-order harmonic signals) of a signal with a predetermined frequency band in the scale-converted image data supplied from the scaler section 22.

Specifically, for example, the supplementary signal generator 30 generates data in which odd function mapping is performed on the signal with a predetermined frequency band in the scale-converted image data.

If the signal with a predetermined frequency band in the scale-converted image data is denoted by X_1, an example of odd function mapping is sgn(X_1)×(X_1)². Here, sgn(X_1) is a function for restoring a sign of the argument X_1. The supplementary signal generator 30 generates data obtained through odd function mapping by calculating sgn(X_1)×(X_1)², that is, by multiplying the signal X_1 with a predetermined frequency band by itself and multiplying the multiplied signal by a sign of the original signal with the predetermined frequency band.

Here, the odd function refers to a function having a property of f(x)=−f(−x), and has a property in which, for example, when f(x)=sin(ωx) is given, a result of the odd function mapping includes odd-order harmonics which are equal to, three times, five times, . . . , and 2n+1 (where n is an integer of 0 or more) times ω.

The adder 24 adds the data obtained through the above-described mapping to the scale-converted image data supplied from the scaler section 22. The adder 24 outputs image data obtained through the addition to the image format conversion unit 14.

In addition, in the first embodiment, a description has been made of a case where the signal supplementing section 23 supplements image data which has been scale-converted by the scaler section with a signal. However, the first embodiment is not limited thereto, and the signal supplementing section 23 may supplement the image data from which noise has been reduced with a signal in which mapping is performed on a signal with a predetermined frequency band in image data from which noise has been reduced by the noise reducing section 21.

In this case, the supplementary signal generator 30 performs odd function mapping on a signal with a predetermined frequency band in an image signal from which noise has been reduced by the noise reducing section 21, so as to generate a signal obtained through the odd function mapping. In addition, the adder 24 adds the signal obtained through the odd function mapping to the noise-reduced image signal.

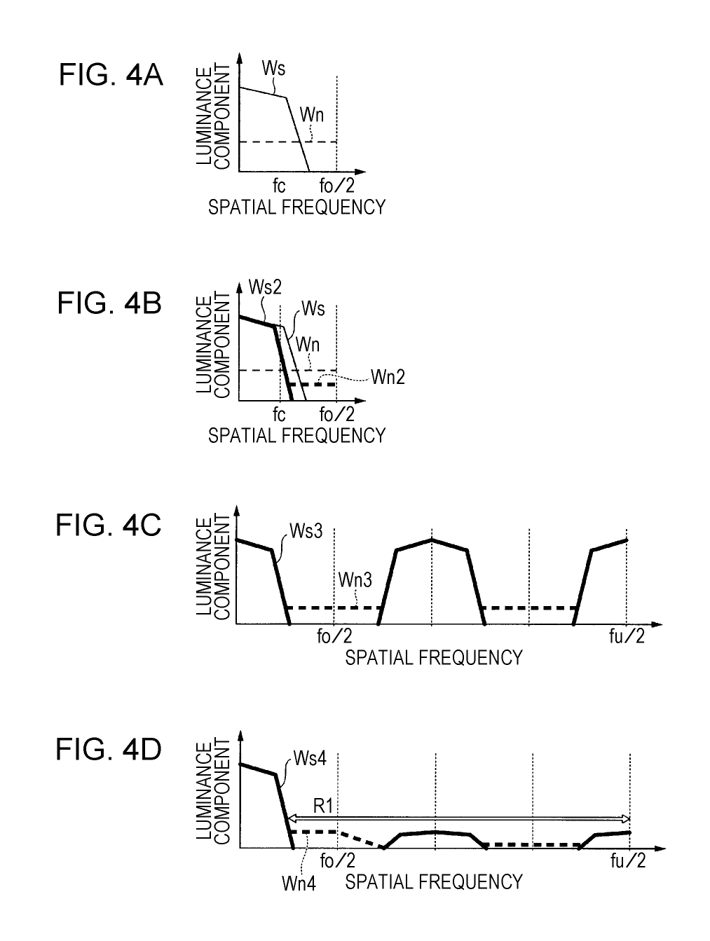

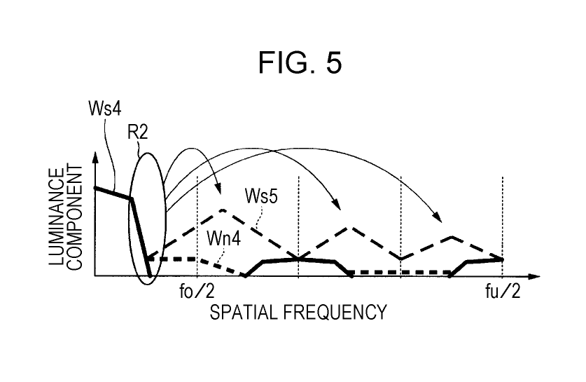

A process performed by the image processing unit 20 will be described with reference to FIGS. 4A to 4D and FIG. 5. FIGS. 4A to 4D are diagrams illustrating an outline of processes performed by the noise reducing section 21 and the scaler section 22. In FIGS. 4A to 4D, a relationship between a luminance component and a spatial frequency in image data is shown. FIG. 4A shows a signal component Ws from which noise is not reduced by the noise reducing section 21 and a noise component Wn.

The graph of FIG. 4B shows a noise-reduced signal component Ws2 and a noise-reduced noise component Wn2 obtained by the noise reducing section 21 reducing noise from the signal including the signal component Ws and the noise component Wn shown in the graph of FIG. 4A. Looking at the noise-reduced noise component Wn2, it is seen that the noise component which is distributed at a frequency lower than the cutoff frequency fc of a low-pass filter is removed due to the noise reduction by the noise reducing section 21, and the noise component remains in the vicinity (fo/2) of the Nyquist frequency region. In addition, looking at the signal component Ws2, it is seen that, also in the signal component, the luminance component of the high frequency band is slightly removed along with the noise component due to the noise reduction by the noise reducing section 21.

The graph of FIG. 4C shows an interpolated and noise-reduced signal component Ws3 and an interpolated and noise-reduced noise component Wn3 obtained by the scaler section 22 interpolating the signal including the noise-reduced signal component Ws2 and the noise-reduced noise component Wn2 shown in the graph of FIG. 4B.

As shown in the graph of FIG. 4C, the scaler section 22 expands the band fo/2 which is a pre-upscaling band, to a band fu/2 which is a post-upscaling band, through interpolation of pixels.

The graph of FIG. 4D shows a signal component Ws4 having undergone low-pass filtering and a noise component Wn4 having undergone low-pass filtering, obtained by the scaler section 22 applying a low-pass filter with the cutoff frequency (fo/2) to the signal including the noise-reduced signal component Ws3 before being interpolated and the interpolated and noise-reduced noise component Ws3 shown in the graph of FIG. 4C.

In addition, the graph of FIG. 4D shows a region R1 where there is almost no signal component due to the low-pass filter with the cutoff frequency (fo/2).

As shown in FIG. 4D, the scaler section 22 reduces an aliasing component after the up-scaling is performed, using the low-pass filter (LPF) with the cutoff frequency (fo/2).

FIG. 5 is a diagram illustrating a process performed by the signal supplementing section 23. FIG. 5 shows a signal component Ws5 in which the signal supplementing section 23 supplements, with a signal, the signal including the signal component Ws4 having undergone low-pass filtering and the noise component Wn4 having undergone low-pass filtering.

The signal supplementing section 23 extracts a signal of a high frequency region R2 within a signal component, which is equal to or lower than the spatial frequency fo/2, in the signal component Ws4 having undergone low-pass filtering, and makes the extracted signal of the high frequency region R2 pass through a nonlinear function. Accordingly, the signal supplementing section 23 supplements, with the signal, the signal component Ws4 having undergone low-pass filtering in the spatial frequency higher than the spatial frequency fo/2 where there is almost no signal component, so as to generate a supplemented signal component Ws5.

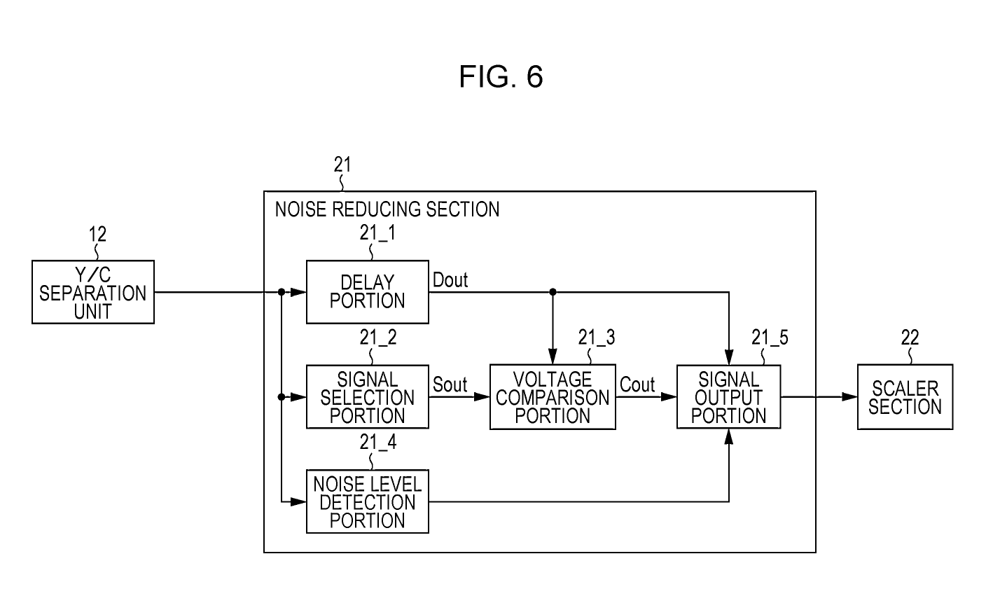

Next, details of a process performed by the noise reducing section 21 will be described with reference to FIG. 6. FIG. 6 is a schematic block diagram of the noise reducing section 21. The noise reducing section 21 includes a delay portion 21_1, a signal selection portion 21_2, a voltage comparison portion 21_3, a noise level detection portion 21_4, and a signal output portion 21_5.

Hereinafter, a process performed by each portion of the noise reducing section 21 will be described. Hereinafter, as an example, a process of the noise reducing section 21 reducing noise from luminance data will be described, but the same process may be performed on color difference data Cb and color difference data Cr in parallel to the luminance data.

The delay portion 21_1 delays pixel data of a target pixel by a predetermined time so as to match timing when pixel data of a pixel (hereinafter, referred to as a comparative pixel) which is compared with the target pixel is output from the signal selection portion 21_2 in relation to an image signal supplied from the Y/C separation unit 12. The delay portion 21_1 outputs the pixel data of the target pixel to the voltage comparison portion 21_3 and the signal output portion 21_5.

The signal selection portion 21_2 sequentially shifts image signals which are transmitted through raster scanning by an amount of data corresponding to one pixel, and stores pixel data from a shift amount 0 to a shift amount (S1+S2).

Here, a pixel of the shift amount 0 is referred to as a left pixel, a pixel shifted by the shift amount S1 is referred to as a target pixel, and a pixel shifted by the shift amount (S1+S2) is referred to as a right pixel.

The signal selection portion 21_2 compares the left pixel, the target pixel, and the right pixel with each other, and outputs pixel data Sout indicating an intermediate pixel value among the three pixels to the voltage comparison portion 21_3.

The voltage comparison portion 21_3 compares the image data Dout of the target pixel supplied from the delay portion 21_1 with the pixel data Sout indicating an intermediate pixel value supplied from the signal selection portion 21_2.

The voltage comparison portion 21_3 sets a comparison operator Cout to 1 if the image data Dout of the target pixel is larger than the pixel data Sout indicating an intermediate pixel value, sets the comparison operator to 0 if they are the same as each other, and sets the comparison operator Cout to −1 if the image data Dout is smaller than the pixel data Sout.

In addition, the voltage comparison portion 21_3 outputs information indicating the value of the comparison operator Cout to the signal output portion 21_5.

In addition, the delay portion 21_1 may be omitted, and the voltage comparison portion 21_3 may calculate the comparison operator Cout by using a pixel value of the target pixel extracted by the signal selection portion 21_2 as it is.

The noise level detection portion 21_4 estimates a noise level on the basis of image data in a blanking section. Specifically, for example, the noise level detection portion 21_4 calculates an average value of the luminance data Y included in image data in the blanking section, and outputs information indicating the calculated average value to the signal output portion 21_5 as a noise level L.

The signal output portion 21_5 receives the pixel data Dout of the target pixel supplied from the delay portion 21_1, the information indicating the value of the comparison operator Cout supplied from the noise level detection portion 21_4, and the noise level L supplied from the noise level detection portion. In addition, the signal output portion 21_5 performs the following process on the pixel data of the target pixel.

The signal output portion 21_5 generates subtraction-resultant image data obtained by subtracting the noise level L from the pixel data Dout. In addition, the signal output portion 21_5 generates addition-resultant image data obtained by adding the noise level L to the pixel data Dout.

The signal output portion 21_5 outputs the subtraction-resultant image data to the scaler section 22 when a value of the comparison operator Cout is 1. The signal output portion 21_5 outputs the pixel data Dout to the scaler section 22 as it is when a value of Cout is 0. The signal output portion 21_5 outputs the addition-resultant image data to the scaler section 22 when a value of Cout is −1.

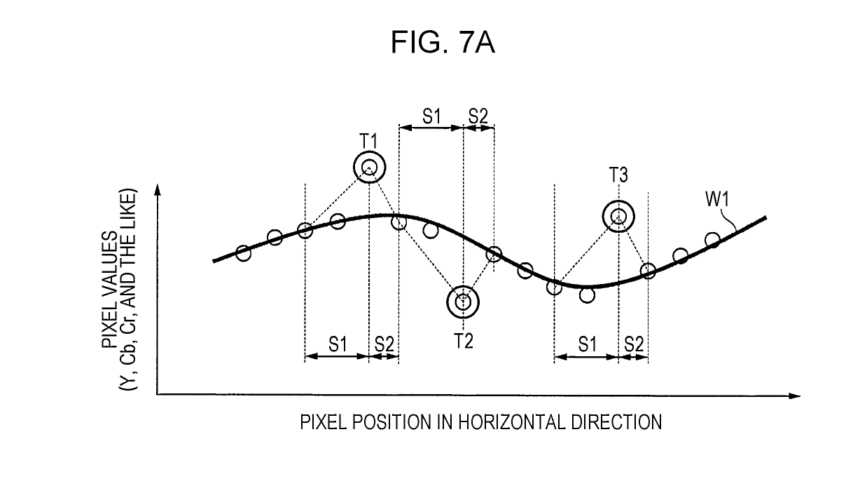

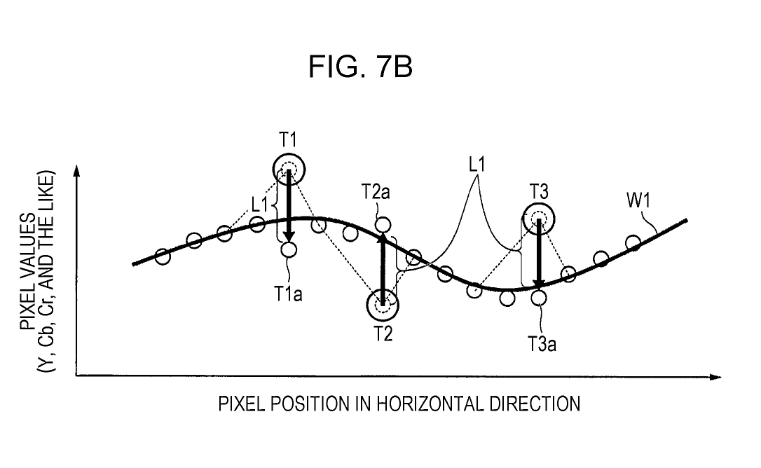

FIGS. 7A and 7B are diagrams illustrating a process performed by the signal output portion 21_5. The graph of FIG. 7A shows an example of a relationship between pixel values (luminance data Y, color difference data Cb, and color difference data Cr) and a pixel position in the horizontal direction. In addition, the graph of FIG. 7B shows an example of a relationship between pixel values (luminance data Y, color difference data Cb, and color difference data Cr) after noise is reduced in the pixel values in FIG. 7A and a pixel position in the horizontal direction.

In FIGS. 7A and 7B, each circle indicates a pixel value of each pixel supplied from the Y/C separation unit 12. A true pixel value W1 is a pixel value of an original image before being wirelessly transmitted from a television tower. As shown in the graph of FIG. 7A, there are cases where each pixel value supplied from the Y/C separation unit 12 deviates from the true pixel value W1 since a noise component is mixed thereinto during wireless transmission.

FIG. 7B shows pixel values of target pixels (T1a, T2a, and T3a) after noise is reduced in pixel values of target pixels (T1, T2, and T3). Here, pixels separate from the target pixels (T1, T2, and T3) to the left by the sampling interval S1, and pixels separate therefrom to the right by the sampling interval S2, are used as respective comparative pixels.

Since the target pixel T1 has a pixel value larger than those of the two comparative pixels, the signal output portion 21_5 subtracts a noise level L1 from the pixel value of the target pixel, and sets a subtraction-resultant pixel value as a pixel value of the noise-reduced target pixel T1a.

In addition, since the target pixel T2 has a pixel value smaller than those of the two comparative pixels, the signal output portion 21_5 adds the noise level L1 to the pixel value of the target pixel, and outputs an addition-resultant pixel value as a pixel value of the noise-reduced target pixel T2a.

Similarly, since the target pixel T3 has a pixel value larger than those of the two comparative pixels, the signal output portion 21_5 subtracts the noise level L1 from a pixel value of the target pixel, and sets a subtraction-resultant pixel value as a pixel value of the noise-reduced target pixel T3a.

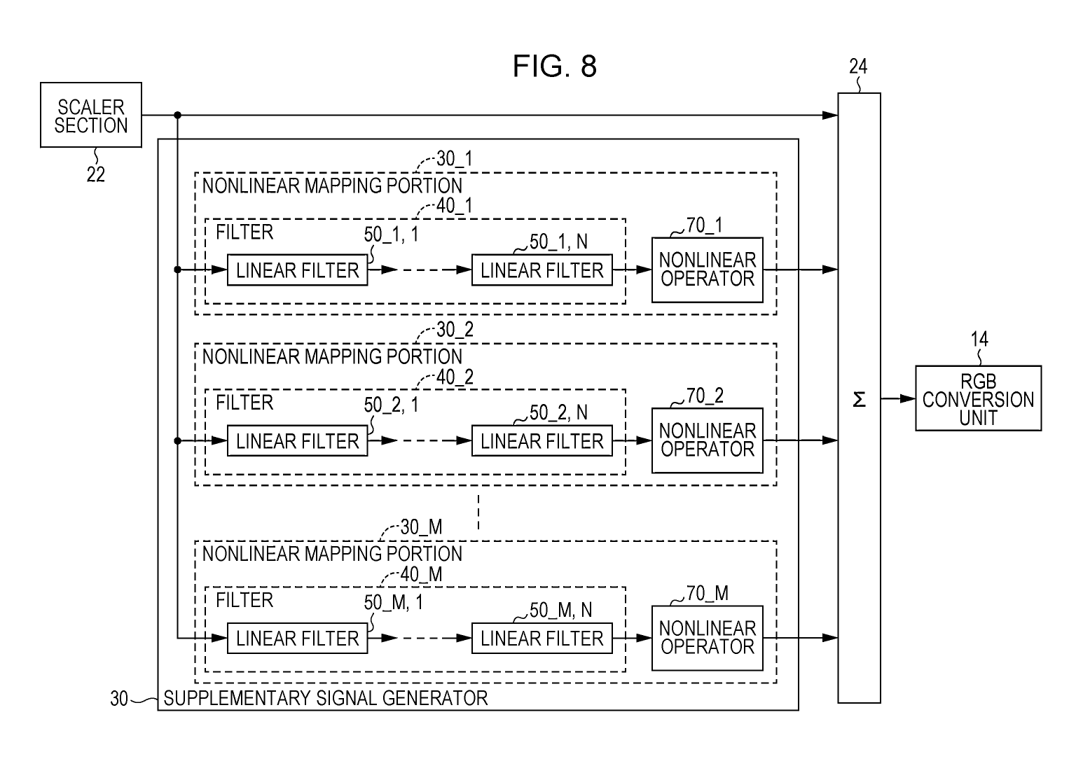

Next, a process performed by the supplementary signal generator 30 will be described with reference to FIG. 8. FIG. 8 is a schematic block diagram of the supplementary signal generator 30.

The supplementary signal generator 30 includes one or more nonlinear mapping portions. Specifically, the supplementary signal generator 30 has M nonlinear mapping portions 30_{—}i (where i is an integer of 1 to M) including nonlinear mapping portions 30_1, 30_2, . . . and 30_M (where M is a positive integer).

A plurality of nonlinear mapping portions 30_1 to 30_M are prepared so that a frequency band is selected by a filter, and an appropriate nonlinear operation is performed on each frequency band. For example, a filter 40_1 of the nonlinear mapping portion 30_1 selects a band so that a frequency of 0.2×fo/2 is centered and performs a nonlinear operation of X̂5. In addition, a filter 40_2 of the nonlinear mapping portion 30_2 selects a band so that a frequency of 0.3×fo/2 is centered and performs a nonlinear operation of X̂3. Accordingly, it is possible to realize predetermined nonlinear mapping according to a frequency band.

Each nonlinear mapping portion 30_{—}i extracts an underlying signal of a high frequency component for being supplemented to scaled-converted image data from the scaled-converted image data which is supplied from the scaler section 22. Specifically, for example, each nonlinear mapping portion 30_{—}i extracts a high frequency component of a predetermined frequency or more from the image data.

Here, the high frequency component corresponds to a contour of an image region (an object) in an image, a fine texture of an object such as the eye of a person, or the like.

Each nonlinear mapping portion 30_{—}i performs a nonlinear operation on the extracted high frequency component. Each nonlinear mapping portion 30_{—}i outputs a nonlinear operation-resultant signal to the adder 24.

Here, each nonlinear mapping portion 30_{—}i includes a filter 40_{—}i and a nonlinear operator 70_{—}i. Each filter 40_{—}i has N linear filters 50_{—}i,j (where i is an integer of 1 to M, and j is an integer of 1 to N) including linear filters 50_{—}i,1, . . . and 50_{—}i,N (where N is a positive integer).

Each filter 40_{—}i has one or more high-pass filters. In other words, at least one of the N linear filters 50_{—}i,j (where j is an integer of 1 to N) included in each filter 40_{—}i is a high-pass filter.

Each filter 40_{—}i makes a signal with a frequency higher than a predetermined frequency in image data pass through the N linear filters 50_{—}i,j included in each filter 40_{—}i in a one-dimensional direction or in a two-dimensional direction. Therefore, a signal which is a source of a high frequency component which is supplemented to scale-converted image data is extracted. Each filter 40_{—}i outputs the extracted signal which is a source of a high frequency component to the nonlinear operator 70_{—}i.

In addition, each filter 40_{—}i has only the linear filters 50_{—}i,j in the first embodiment, but is not limited thereto, and may have nonlinear filters.

Each nonlinear operator 70_{—}i generates a signal with a frequency component higher than that of the signal which is a source of a high frequency component on the basis of the signal which is a source of a high frequency component extracted by each filter 40_{—}i. Specifically, for example, each nonlinear operator 70_{—}i performs an odd function mapping on the signal which is a source of a high frequency component, extracted within a certain time. Each nonlinear operator 70_{—}i outputs image data obtained through the odd function mapping to the adder 24.

Generally, a nonlinear function is expressed by a sum of an even function and an odd function. A function having a relation of f(x)=−f(−x) is called an odd function, and a function having a relation of f(x)=f(−x) is called an even function. Here, a description will be made of the reason for using not the even function but the odd function.

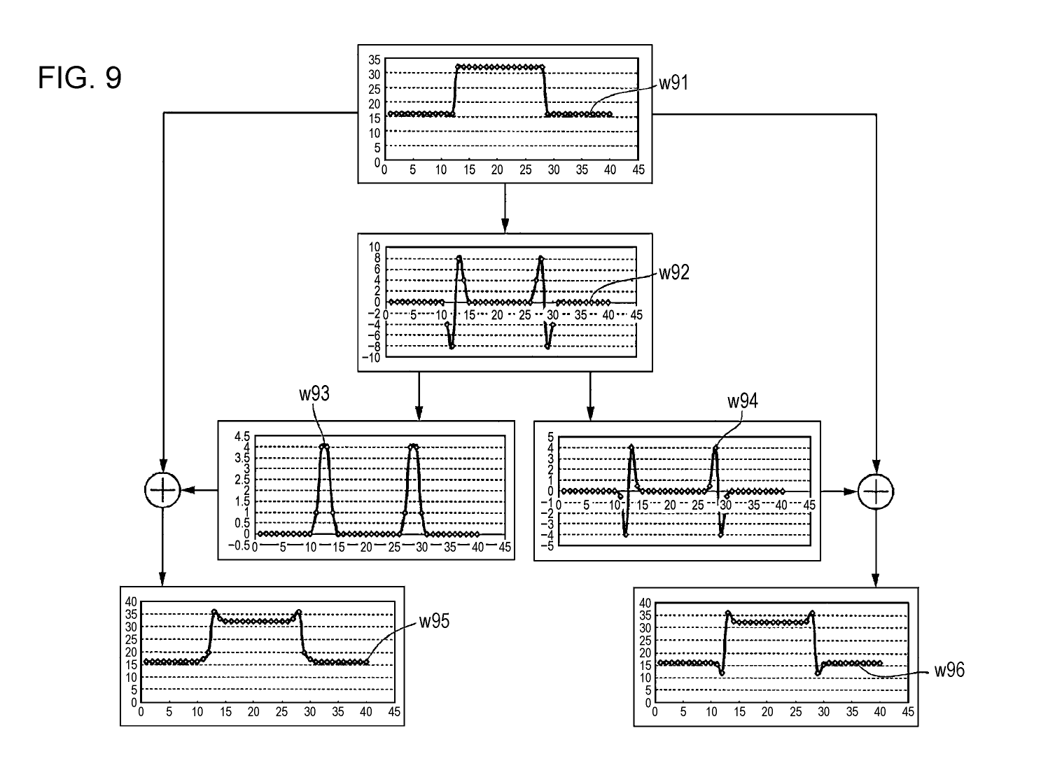

FIG. 9 is a diagram illustrating an example in which waveforms output from the adder 24 are compared with each other when a signal passes through nonlinear functions of an even function and an odd function in the nonlinear operator. FIG. 9 shows a waveform w91 of an original signal which varies in a step shape as an example of an original signal supplied from the scaler section 22. In addition, FIG. 9 shows a waveform w92 of the signal after the original signal w91 varying in a step shape passes through the high-pass filter of the filter 40_{—}i.

FIG. 9 further shows a waveform w93 of the signal after the signal having passed through the high-pass filter passes through a nonlinear function of the even function and a waveform w94 of the signal after the signal having passed through the high-pass filter passes through a nonlinear function of the odd function. In addition, FIG. 9 shows a waveform w95 of a signal obtained by adding the original signal to the signal having passed through the nonlinear function of the even function and a waveform w96 of a signal obtained by adding the original signal to the signal having passed through the nonlinear function of the odd function.

In the example of FIG. 9, the signal having passed through the high-pass filter has the numerical values including positive values and negative values. In a case where an even function is applied to the signal having passed through the high-pass filter by the nonlinear operator 70_{—}i, when an input is positive, an output is positive, and when an input is negative, an output is positive. Therefore, a positive value is output at all times. Accordingly, in a case where the signal having passed through a nonlinear function of the even function is added to the original signal, an addition-resultant signal shows that a contour (edge) in an image of a location with a high pixel value is enhanced, but an edge of a location with a low pixel value gets blunted.

On the other hand, in a case where an odd function is applied to the signal having passed through the high-pass filter by the nonlinear operator 70_{—}i, when an input is positive, an output is positive, and when an input is negative, an output is negative. In other words, a sign at each point of the signal having passed through the nonlinear function of the odd function is the same as a sign of each point of the signal having passed through the high-pass filter, corresponding to each point. Therefore, in a case where the signal having passed through the nonlinear function of the odd function is added to the original signal, an edge is enhanced in both of a location with a high pixel value and a location with a low pixel value. Thus, the signal supplementing section 23 can realize favorable edge enhancement. In light thereof, the nonlinear operator 70_{—}i preferably uses an odd function.

Accordingly, each nonlinear operator 70_{—}i can generate odd-order harmonics of a signal which is a source of a high frequency component by generating image data obtained through odd function mapping.

The adder 24 can supplement a high frequency band in which there is almost no signal with the signal generated in the above-described way by adding the image data obtained through odd function mapping to the scaled-converted image data supplied from the scaler section 22.

In addition, the use of odd function mapping has an advantage in that, even if the adder 24 adds image data obtained through the odd function mapping to scale-converted image data, it is difficult to influence a DC component (average luminance) of the scale-converted image data.

Each nonlinear operator 70_{—}i according to the first embodiment uses odd function mapping since it is difficult for the odd function mapping to influence a DC component (average luminance), but is not limited thereto. Each nonlinear operator 70_{—}i may use even function mapping. In this case, in order to remove a DC component generated through even function mapping, each nonlinear operator 70_{—}i may perform filtering for removing the DC component after performing the even function mapping.

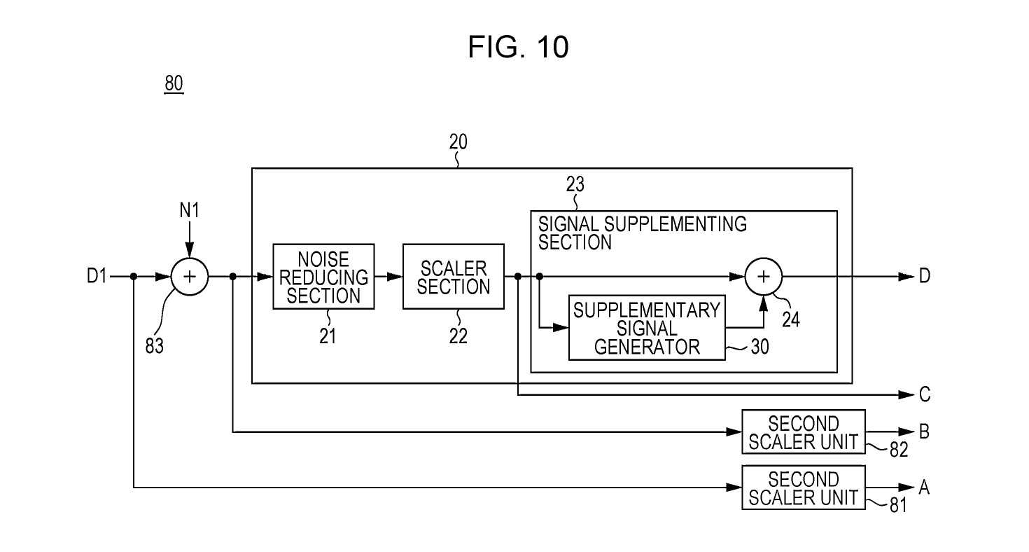

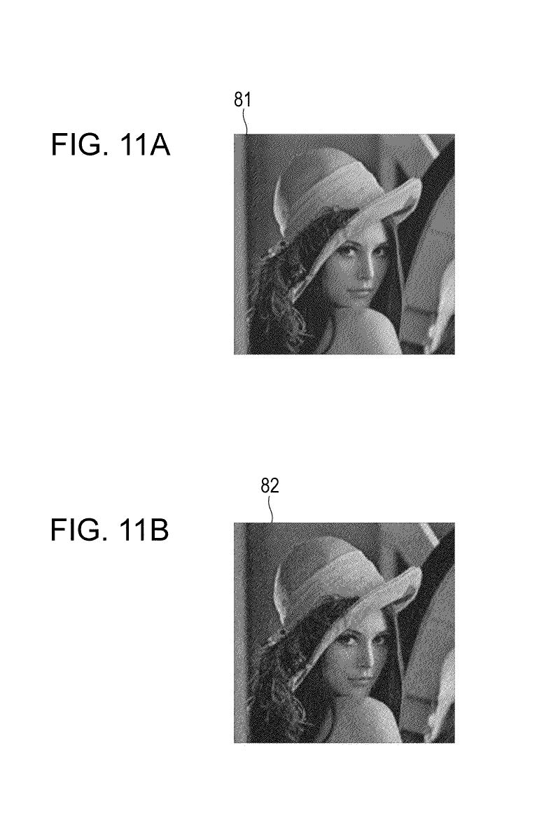

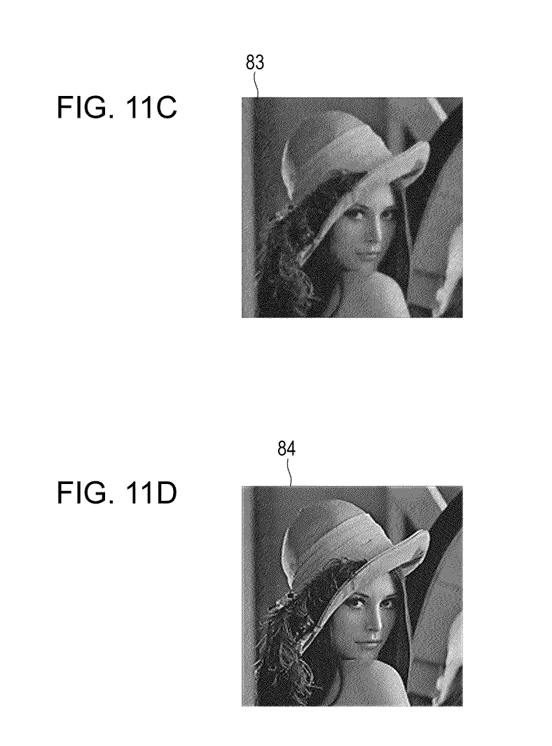

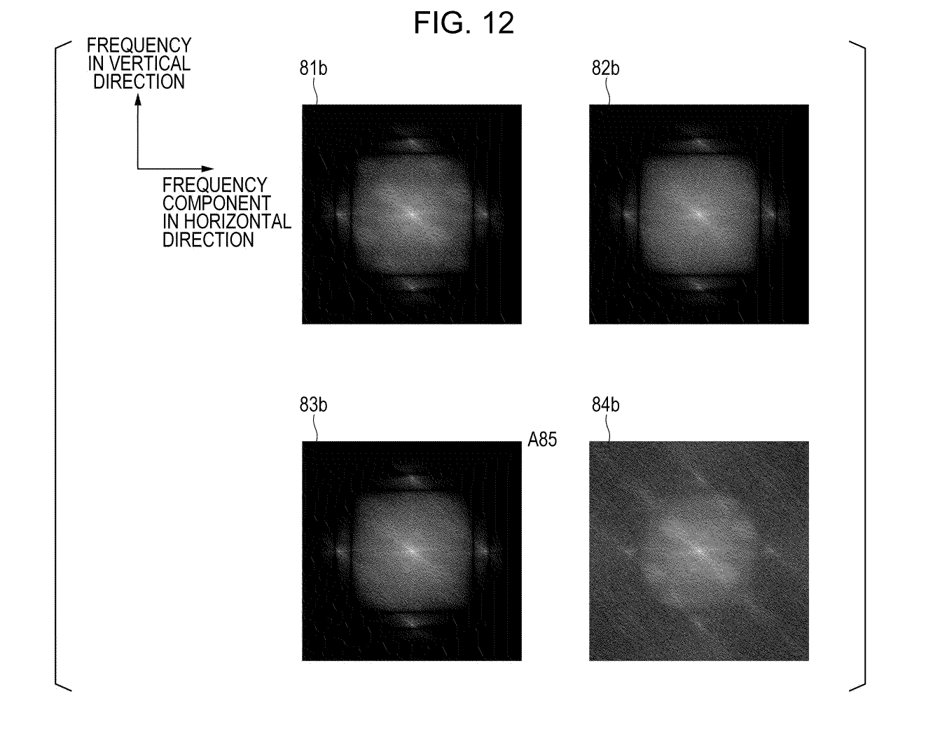

Successively, a description will be made of effects achieved by the process performed by the signal supplementing section 23 with reference to FIGS. 10 and 11A to 11D. FIG. 10 is a functional block diagram of a confirmation device 80 for confirming effects achieved by the signal supplementing section 23. The confirmation device 80 includes the image processing unit 20, a first scaler unit 81, a second scaler unit 82, and an adder 83.

The first scaler unit 81 scales up original image data which does not have noise input from outside, and outputs up-scaled original image data A to an external device of the confirmation device 80.

The adder 83 adds noise N1 input from outside to original image data D1 having no noise input from outside, and outputs noise addition-resultant image data to the noise reducing section 21 of the image processing unit 20 and the second scaler unit 82. Accordingly, the adder 83 can generate the image data in which the noise N1 is artificially added to the original image data D1 having no noise. In addition, the noise reducing section 21 is the same as the noise reducing section 21 shown in FIG. 6.

The second scaler unit 82 scales up the noise addition-resultant image data, and outputs up-scaled noise image data B to the external device of the confirmation device 80.

The noise reducing section 21 performs a noise reduction process on the noise addition-resultant image data. The scaler section 22 scales up the image data from which noise has been reduced by the noise reducing section 21, and applies a low-pass filter to the up-scaled image data. The scaler section 22 outputs the image data having undergone low-pass filtering to the signal selecting section 23 and the external device of the confirmation device 80 as image data C having undergone the noise reduction process.

The supplementary signal generator 30 of the signal supplementing section 23 performs nonlinear mapping on the image data C having undergone the noise reduction process so as to generate data obtained through the mapping. The adder 24 adds the data obtained through the mapping to the image data C having undergone the noise reduction process, and outputs resultant data to the external device of the confirmation device 80 as signal-supplemented image data D.

FIGS. 11A to 11D are diagrams illustrating the image data items A to D output from the confirmation device 80 of FIG. 10 as images, respectively. FIGS. 11A to 11D respectively show an up-scaled original image 81 (FIG. 11A) corresponding to the image data A, an up-scaled noise image 82 (FIG. 11B) corresponding to the image data B, an image 83 (FIG. 11C) having undergone the noise reduction process corresponding to the image data C, and a signal-supplemented image 84 (FIG. 11D) corresponding to the image data D.

The up-scaled noise image 82 (FIG. 11B) has noise superimposed thereon as compared with the up-scaled original image 81 (FIG. 11A).

In addition, the image 83 (FIG. 11C) having undergone the noise reduction process has noise removed therefrom as compared with the up-scaled noise image 82 (FIG. 11B), but has deteriorated definition as compared with the up-scaled original image 81 (FIG. 11A).

On the other hand, it can be seen that, in the signal-supplemented image 84 (FIG. 11D), the eyes are more obvious, the hair or the lips are glossier, and the skin and the contour part of the background are clearer than in the image 83 (FIG. 11C) having undergone the noise reduction process, and thus definition is obtained.

As above, data, which is obtained by the signal supplementing section 23 performing nonlinear mapping on a signal with a frequency component higher than a predetermined frequency, extracted from scale-converted image data, is supplemented to image data of the scale-converted image data, and thus it is possible to generate a defined image.

FIG. 12 shows signal intensity distributions in the frequency domain of the respective images of FIGS. 11A to 11D. In spectra 81b, 82b, 83b and 84b shown in FIG. 12, a DC component appears at the central part, and a high frequency component appears toward the periphery. In addition, the white colored part indicates that a signal intensity of the frequency component is high. The longitudinal axis expresses a frequency Fx in the horizontal direction of an image, and the transverse axis expresses a frequency Fy in the vertical direction of the image.

A signal intensity S(Fx,Fy) in a frequency domain is a sum of the square of a real component and the square of an imaginary component in a signal component which has Fx as a frequency component in the horizontal direction and Fy as a frequency component in the vertical direction when each image data item is Fourier-transformed.

Accordingly, in the diagonal directions of the spectra 81b, 82b, 83b and 84b of FIG. 12, a signal intensity of each frequency component in the diagonal direction appears.

Here, in the distribution of the signal intensity (spectrum) in the frequency region, the center of the distribution is set as an origin. A sign in the horizontal direction is determined depending on a sign of an imaginary component of a horizontally Fourier-transformed value. A sign in the vertical direction is determined depending on a sign of an imaginary component of a vertically Fourier-transformed value.

FIG. 12 shows the spectrum 81b of the up-scaled original image, the spectrum 82b of the noise addition-resultant image, the spectrum 83b of the image having undergone the noise reduction process, and the spectrum 84b of the signal-supplemented image.

As indicated by the arrow A85, it is shown that the signal intensity in the high frequency region is higher in the spectrum 84b of the signal-supplemented image than in the spectrum 83b of the image having undergone the noise reduction process. It can be seen from this fact that a signal of a high frequency region is supplemented to the image data C having undergone the noise reduction process in the signal supplementing section 23.

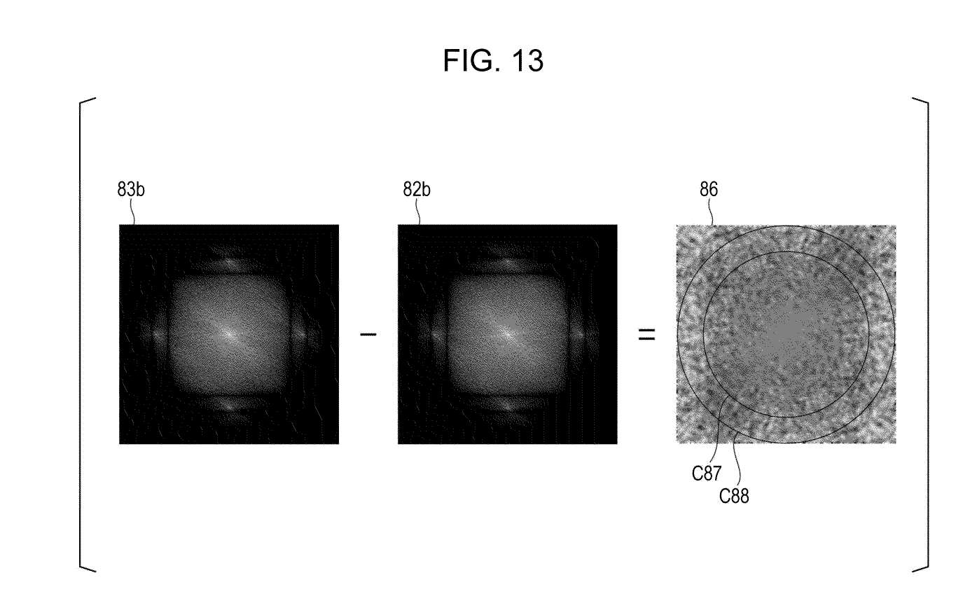

FIG. 13 is a diagram illustrating a spectral difference obtained by subtracting the spectrum of the noise addition-resultant image from the spectrum of the image having undergone the noise reduction process. FIG. 13 shows the spectrum 83b of the image having undergone the noise reduction process, the spectrum 82b of the noise addition-resultant image, and a spectral difference 86 obtained by subtracting the spectrum of the noise addition-resultant image from the spectrum of the image having undergone the noise reduction process.

In the spectral difference 86, the gray part indicates that there is no difference, the black part indicates that a frequency component decreases, and the white part indicates that a frequency increases. In the spectral difference 86, black increases in the doughnut-shaped region surrounded by the small circle C87 and the large circle C88. It can be seen from this fact that a high frequency component becomes less in the image 83 having undergone the noise reduction process than in the noise addition-resultant image 82. This means that one of factors by which the image 83 having undergone the noise reduction process becomes less definite in appearance than the noise addition-resultant image 82 is a reduction in a signal of a frequency region higher than a predetermined frequency.

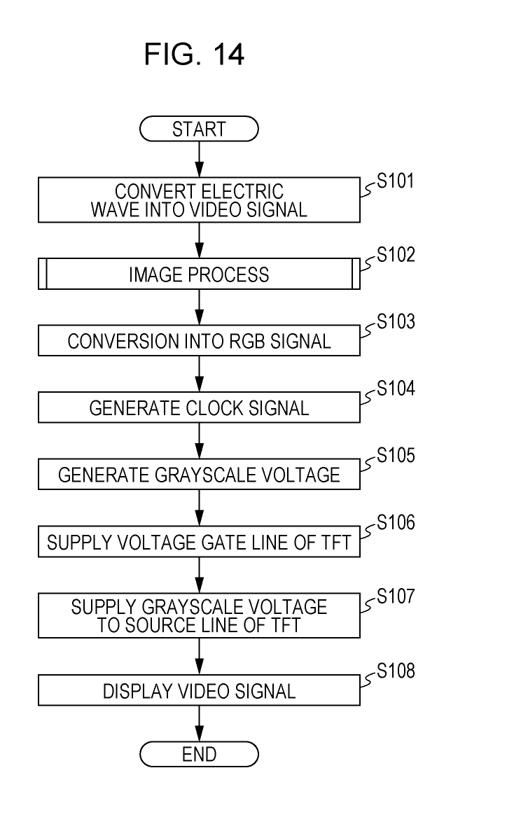

Next, an operation of the overall display device 1 will be described with reference to a flowchart shown in FIG. 14.

FIG. 14 is a flowchart illustrating a flow of the processes performed by the display device 1 (FIG. 1) according to the first embodiment.

The detection unit 11 is supplied with a broadcast wave signal received from the antenna and outputs the supplied signal to the Y/C separation unit 12. In addition, the Y/C separation unit 12 demodulates the signal supplied from the detection unit 11 so as to perform Y/C separation and to then perform A/D conversion, and outputs A/D-converted image data (luminance data Y, color difference data Cb, and color difference data Cr) to the image processing unit 20 (step S101).

Next, the image processing unit 20 performs a predetermined image process on the image data supplied from the Y/C separation unit 12 (step S102). Next, the image format conversion unit 14 performs I (Interlace)/P (Progressive) conversion (conversion of a video created only for use in an interlace type video device into a video appropriate for display in a progressive type) on the image signal having undergone the image process. In addition, the image format conversion unit 14 converts the I/P-converted image signal into an RGB signal (grayscale data of each of red, green, and blue) (step S103).

Next, the liquid crystal driving unit 15 generates a clock signal for writing the supplied RGB signal to the liquid crystal elements PIX which are arranged in a matrix in the liquid crystal panel 16 (step S104).

Next, the liquid crystal driving unit 15 converts the grayscale data of the RGB signal into a grayscale voltage for driving the liquid crystal (step S105).

In addition, the liquid crystal driving unit 15 holds the grayscale voltage in the hold circuit thereof for each source line of the liquid crystal panel 16.

Next, the liquid crystal driving unit 15 supplies a predetermined voltage to any of the gate lines of the liquid crystal panel 16 in synchronization with the generated clock signal, so as to apply the predetermined voltage to the gate electrode of the TFT of the liquid crystal element (step S106).

Next, the liquid crystal driving unit 15 supplies the grayscale voltage which is held for each source line of the liquid crystal panel 16 in correlation with the generated clock signal (step S107).

Due to the above-described processes, the grayscale voltages are sequentially supplied to the source lines during a period when the respective gate lines are selected, and the grayscale voltage (grayscale data) necessary in display is written to the pixel element connected to the drain of the turned-on TFT. Accordingly, the pixel element controls alignment of the inner liquid crystal according to the applied grayscale voltage so as to change transmittance. As a result, the video signal received by the detection unit 11 is displayed on the liquid crystal panel 16 (step S108). Therefore, the processes of the flowchart shown in FIG. 14 end.

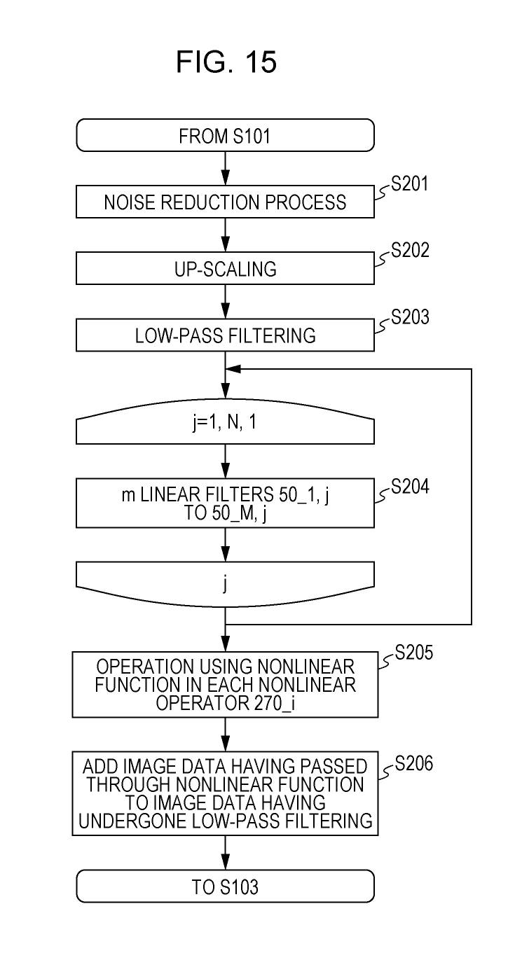

FIG. 15 is a flowchart illustrating details of the process performed by the image processing unit 20 in step S102 of FIG. 14. First, the noise reducing section 21 performs noise reduction on the image data which is input from the Y/C separation unit 12 (step S201). Next, the scaler section 22 scales up the noise-reduced image data (step S202). Subsequently, the scaler section 22 applies a low-pass filter to the up-scaled image data (step S203).

Next, when j is 1, the respective filters 40_{—}i (where i is an integer of 1 to M) apply the M linear filters 50_1,1 to 50_M,1 to the image data having undergone the low-pass filtering in parallel. Thereafter, while j increases by 1, the respective filters 40_{—}i (where i is an integer of 1 to M) apply corresponding linear filters to image data after the preceding linear filter 50_{—}i,j−1 in parallel until j becomes N (step S204).

Next, the nonlinear operators 270_{—}i (where i is an integer of 1 to M) make the image data having undergone linear filtering, output from the respective filters 40_{—}i, pass through a nonlinear function (step S205). Next, the adder 24 adds the image data having passed through the nonlinear function to the image data having undergone low-pass filtering supplied from the scaler section 22 (step S206). Therefore, the processes of the flowchart shown in FIG. 15 end.

As described above, in the image processing unit 20 according to the first embodiment, the filter 40_{—}i extracts data of a predetermined frequency region, included in the image data having undergone low-pass filtering in the scaler section 22. In addition, the nonlinear operator 270_{—}i makes the extracted data pass through a nonlinear function, and the adder 24 adds the data having passed through the nonlinear function to the image data having undergone low-pass filtering.

Accordingly, the image processing unit 20 adds a signal with a frequency component higher than a frequency component included in image data, to the image data, and thus it is possible to obtain a defined image.

### Second Embodiment

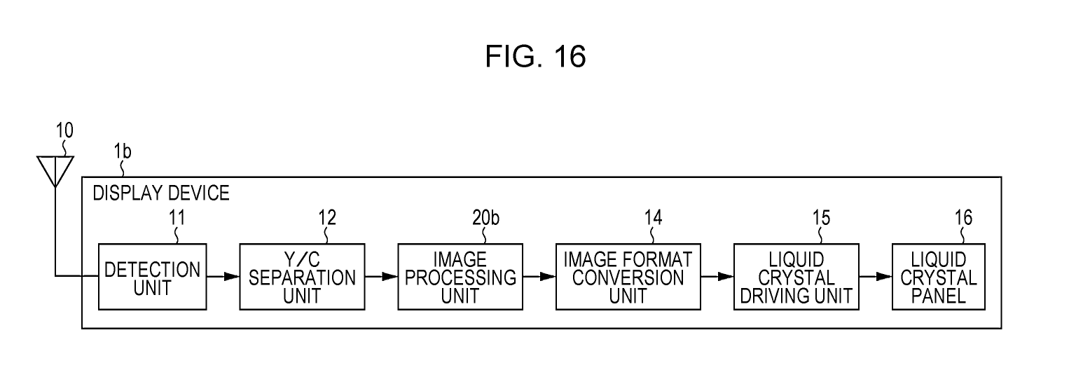

FIG. 16 is a schematic block diagram of a display device 1b according to a second embodiment. In addition, a constituent element common to the display device 1 according to the first embodiment of FIG. 1 is given the same reference numeral, and detailed description thereof will be omitted. In a configuration of the display device 1b of FIG. 16, the image processing unit 20 in the configuration of the display device 1 of FIG. 1 is replaced with an image processing unit 20b.

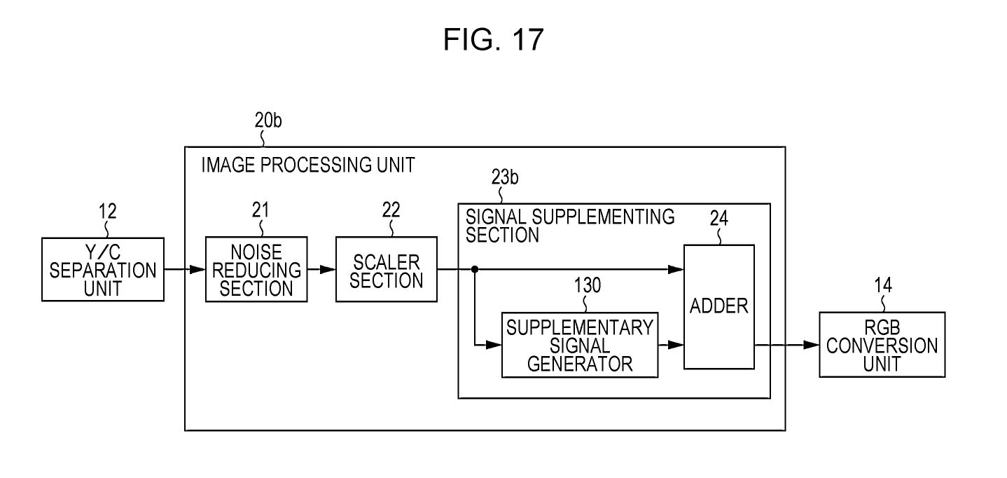

Successively, the image processing unit 20b will be described. FIG. 17 is a schematic block diagram of the image processing unit 20b. In addition, a constituent element common to the image processing unit 20 according to the first embodiment of FIG. 3 is given the same reference numeral, and detailed description thereof will be omitted.

In a configuration of the image processing unit 20b of FIG. 17, the signal supplementing section 23 in the configuration of the image processing unit 20 of FIG. 3 is replaced with a signal supplementing section 23b. In a configuration of the signal supplementing section 23b, the supplementary signal generator 30 in the configuration of the signal supplementing section 23 of FIG. 3 is replaced with a supplementary signal generator 130.

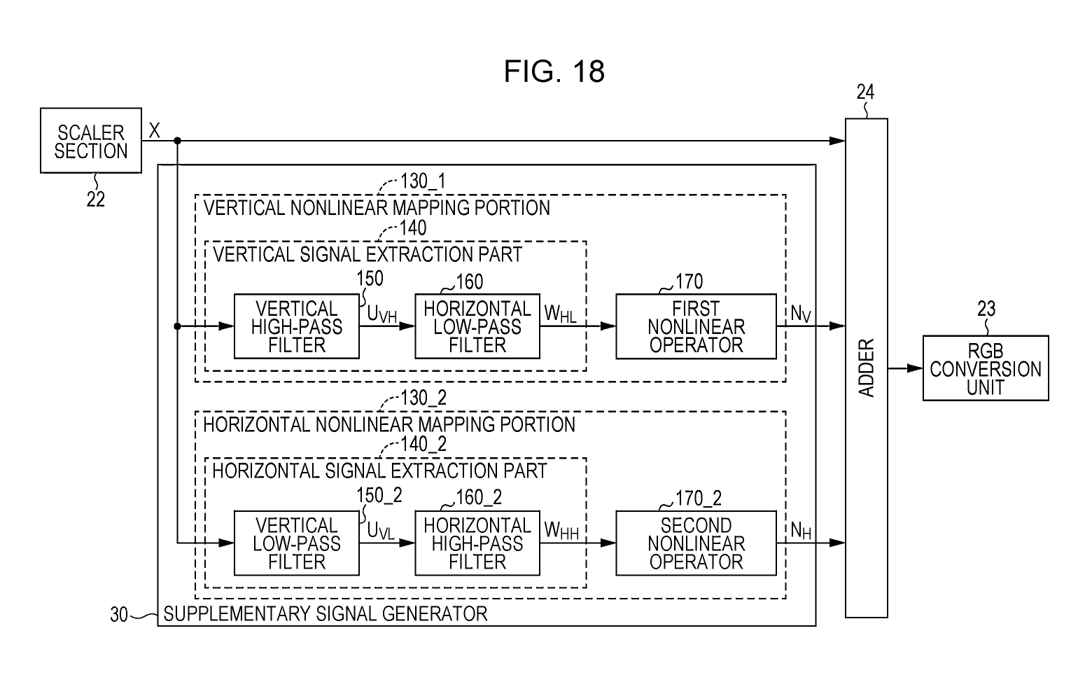

Next, the supplementary signal generator 130 will be described with reference to FIG. 18. FIG. 18 is a functional block diagram of the supplementary signal generator 130 according to the second embodiment. The supplementary signal generator 130 includes a vertical nonlinear mapping portion 130_1 and a horizontal nonlinear mapping portion 130_2.

The vertical nonlinear mapping portion 130_1 includes a vertical signal extraction part 140 and a first nonlinear operator 170. Here, the vertical signal extraction part 140 includes a vertical high-pass filter 150 and a horizontal low-pass filter 160.

The vertical high-pass filter 150 extracts a vertical high frequency component of scale-converted image data X which is supplied from the scaler section 22, and outputs image data U_{VH} including the extracted vertical high frequency component to the horizontal low-pass filter 160.

The horizontal low-pass filter 160 extracts a horizontal low frequency component of the image data U_{VH} with the vertical high frequency component supplied from the vertical high-pass filter 150, and outputs image data W_{HL} including the extracted horizontal low frequency component to the first nonlinear operator 170.

The first nonlinear operator 170 performs nonlinear mapping on a signal of the image data W_{HL} including the horizontal low frequency component supplied from the horizontal low-pass filter 160. Accordingly, data N_{V} for supplementing the vertical high frequency component which disappears in the scale-converted image data X is generated, and the generated data N_{V} for supplementing the vertical high frequency component is output to the adder 24.

In addition, in the second embodiment, the process by the vertical high-pass filter 150 is followed by the process by the horizontal low-pass filter 160. However, the second embodiment is not limited thereto, and the vertical high-pass filter 150 and the horizontal low-pass filter 160 are linear filters, and thus either one may be disposed first in principle.

Next, a process performed by the horizontal nonlinear mapping portion 130_2 will be described. The horizontal nonlinear mapping portion 130_2 includes a horizontal signal extraction part 140_2 and a second nonlinear operator 170_2. Here, the horizontal signal extraction part 140_2 includes a vertical low-pass filter 150_2 and a horizontal high-pass filter 160_2.

The vertical low-pass filter 150_2 extracts a vertical low frequency component of the scale-converted image data X, and outputs image data U_{VL} including the extracted vertical low frequency component to the horizontal high-pass filter 160_2.

The horizontal high-pass filter 160_2 extracts a horizontal high frequency component of the image data U_{VL} including the vertical low frequency component supplied from the vertical low-pass filter 150_2, and outputs image data W_{HH} including the extracted horizontal high frequency component to the second nonlinear operator 170_2.

In addition, in the second embodiment, the process by the vertical low-pass filter 150_2 is followed by the process by the horizontal high-pass filter 160_2. However, the second embodiment is not limited thereto, and the vertical low-pass filter 150_2 and the horizontal high-pass filter 160_2 are linear filters, and thus either one may be disposed first in principle.

The second nonlinear operator 170_2 performs nonlinear mapping on a signal of the image data W_{HH} including the horizontal high frequency component supplied from the horizontal high-pass filter 160_2. Accordingly, data N_{H} for supplementing the horizontal high frequency component which disappears in the scale-converted image data X is generated, and the generated data N_{H} for supplementing the horizontal high frequency component is output to the adder 24.

The adder 24 adds the scale-converted image data X, the data N_{V} for supplementing the vertical high frequency component supplied from the first nonlinear operator 170, and the data N_{H} for supplementing the horizontal high frequency component supplied from the second nonlinear operator 170_2 together, and outputs image data obtained through the addition to the image format conversion unit 23.

In addition, in a case where a range of pixel values which can be output is finite such as 0 to 255, a limiter for limiting pixel values to the range may be provided in the adder 24.

In addition, in a case where a high frequency component is included in both horizontal and vertical directions, the adder 24 may perform the following process. For example, the adder 24 may multiply the signal N_{V} for supplementing a vertical high frequency component and the signal N_{H} for supplementing a horizontal high frequency component by weights. In addition, the adder 24 may add a value obtained by multiplying a sum of the signal N_{V} for supplementing a vertical high frequency component and the signal N_{H} for supplementing a horizontal high frequency component by a weight, to the scale-converted image data X. Further, the adder 24 may multiply a sum of the signal N_{V} for supplementing a vertical high frequency component, the signal N_{H} for supplementing a horizontal high frequency component, and the scale-converted image data X, by a weight.

In other words, the adder 24 may change the scale-converted image data X on the basis of the signal N_{V} for supplementing a vertical high frequency component and the signal N_{H} for supplementing a horizontal high frequency component. Accordingly, in a pixel in which a high frequency component is included in both horizontal and vertical directions, it is possible to prevent excessive enhancement in the pixel.

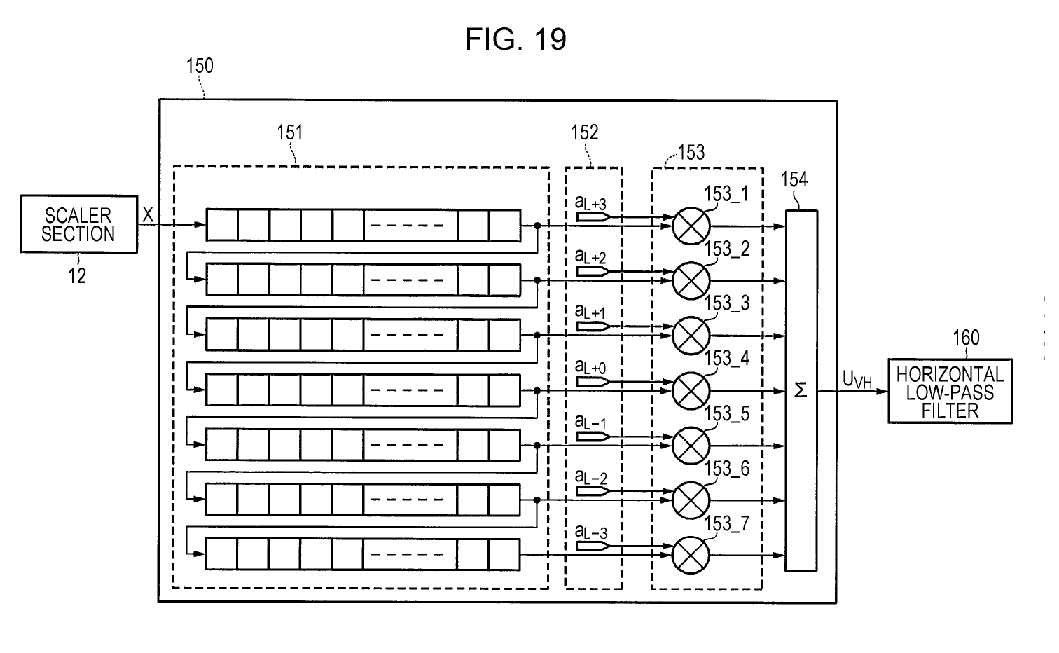

Next, details of a process performed by the vertical high-pass filter 150 will be described with reference to FIG. 19. FIG. 19 shows an example of a functional block diagram of the vertical high-pass filter 150 according to the second embodiment.

The vertical high-pass filter 150 includes a vertical pixel reference delay part 151, a filter coefficient storage part 152, a multiplying part 153, and an adder 154. Here, the multiplying part 153 has seven multipliers including multipliers 153_1 to 153_7.

The vertical pixel reference delay part 151 delays the scale-converted image data X supplied from the scaler section 22 by the number of pixels of a horizontal synchronization signal of one line, and outputs one-line delayed data obtained through the delay to the multiplier 153_1 of the multiplying part 153.

The vertical pixel reference delay part 151 further delays the one-line delayed data by the number of pixels of the horizontal synchronization signal of one line, and outputs two-line delayed data obtained through the delay to the multiplier 153_2 of the multiplying part 153.

In this way, the vertical pixel reference delay part 151 outputs k (where k is an integer of 1 to 7)-line delayed data obtained through delay by the number of pixels of the horizontal synchronization signal of k lines to the multiplier 153_{—}k of the multiplying part 153.

The filter coefficient storage part 152 stores data indicating a vertical coefficient a_{L-3} of the third next line, data indicating a vertical coefficient a_{L-2} of the second next line, data indicating a vertical coefficient a_{L-1} of the next line, data indicating a vertical coefficient a_{L+0} of the target line, data indicating a vertical coefficient a_{L+1} of the preceding line, data indicating a vertical coefficient a_{L+2} of the second preceding line, and data indicating a vertical coefficient a_{L+3} of the third preceding line.

The multiplier 153_1 reads the data indicating the vertical coefficient a_{L-3} of the third preceding line. The multiplier 153_1 multiplies the one-line delayed data which is input from the vertical pixel reference delay part 151 by the vertical coefficient a_{L-3} of the third preceding line, and outputs data obtained through the multiplication to the adder 154.

The multiplier 153_2 reads the data indicating the vertical coefficient a_{L-2} of the second preceding line. The multiplier 153_2 multiplies the two-line delayed data which is input from the vertical pixel reference delay part 151 by the vertical coefficient a_{L-2} of the second preceding line, and outputs data obtained through the multiplication to the adder 154.

The multiplier 153_3 reads the data indicating the vertical coefficient a_{L-1} of the preceding line. The multiplier 153_3 multiplies the three-line delayed data which is input from the vertical pixel reference delay part 151 by the vertical coefficient a_{L-1} of the preceding line, and outputs data obtained through the multiplication to the adder 154.

The multiplier 153_4 reads the data indicating the vertical coefficient a_{L+0} of the target line. The multiplier 153_4 multiplies the four-line delayed data which is input from the vertical pixel reference delay part 151 by the vertical coefficient a_{L+0} of the target line, and outputs data obtained through the multiplication to the adder 154.

The multiplier 153_5 reads the data indicating the vertical coefficient a_{L+1} of the next line. The multiplier 153_5 multiplies the five-line delayed data which is input from the vertical pixel reference delay part 151 by the vertical coefficient a_{L+1} of the next line, and outputs data obtained through the multiplication to the adder 154.

The multiplier 153_6 reads the data indicating the vertical coefficient a_{L+2} of the second next line. The multiplier 153_6 multiplies the six-line delayed data which is input from the vertical pixel reference delay part 151 by the vertical coefficient a_{L+2} of the second next line, and outputs data obtained through the multiplication to the adder 154.

The multiplier 153_7 reads the data indicating the vertical coefficient a_{L+3} of the third next line. The multiplier 153_7 multiplies the seven-line delayed data which is input from the vertical pixel reference delay part 151 by the vertical coefficient a_{L+3} of the third next line, and outputs data obtained through the multiplication to the adder 154.

The adder 154 adds the data items supplied from the respective multipliers 153_{—}k together, and outputs image data obtained through the addition to the horizontal low-pass filter 60 as image data U_{VH} including a vertical high frequency component.

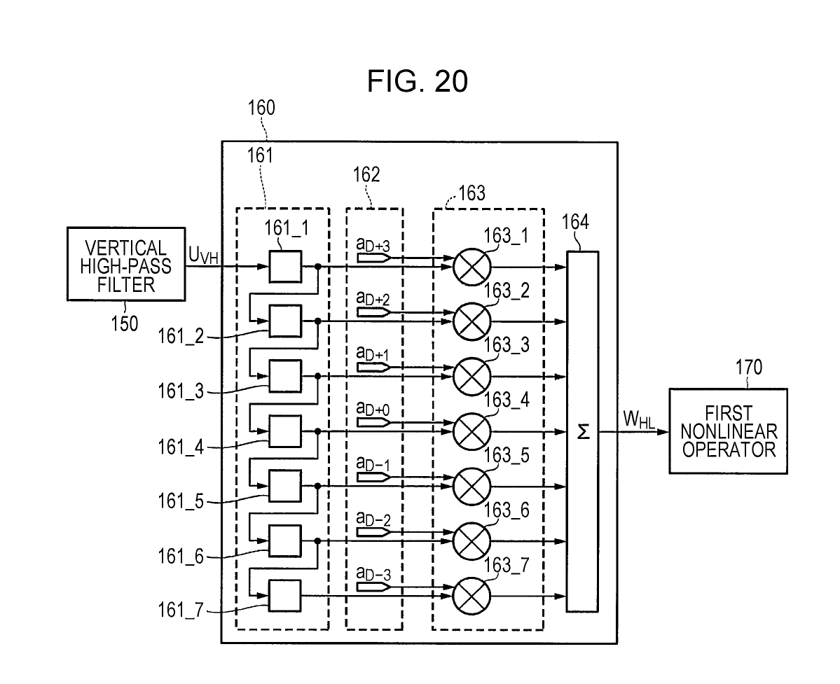

Successively, details of a process performed by the horizontal low-pass filter 160 will be described with reference to FIG. 20. FIG. 20 is a functional block diagram of the horizontal low-pass filter 160 according to the second embodiment. The horizontal low-pass filter 160 includes a horizontal pixel reference delay part 161, a filter coefficient storage part 162, a multiplying part 163, and an adder 164. Here, the multiplying part 163 has seven multipliers including multipliers 163_1 to 163_7.

The horizontal pixel reference delay part 161 includes seven one-pixel delay elements including one-pixel delay elements 161_1 to 161_7.

The one-pixel delay element 161_1 delays the image data U_{VH} including a vertical high frequency component supplied from the vertical high-pass filter 150 by one pixel, and outputs one-pixel delayed data which is delayed by one pixel to the multiplier 163_1 of the multiplying part 163 and the one-pixel delay element 161_2.

The one-pixel delay element 161_2 delays the one-pixel delayed data supplied from the one-pixel delay element 161_1 by one pixel, and outputs two-pixel delayed data which is delayed by one pixel to the multiplier 163_2 of the multiplying part 163.

In this way, the one-pixel delay element 161_{—}k (where k is an integer of 1 to 7) delays one-pixel delayed data supplied from the one-pixel delay elements 161_{—}k−1 by one pixel, and outputs k-pixel delayed data which is delayed by one pixel to the multiplier 163_{—}k of the multiplying part 163.

The filter coefficient storage part 162 stores data indicating a filter coefficient a_{D+3} of the third preceding pixel, data indicating a filter coefficient a_{D+2} of the second preceding pixel, data indicating a filter coefficient a_{D+1} of the preceding pixel, data indicating a filter coefficient a_{D0} of the target pixel, data indicating a filter coefficient a_{D-1} of the next pixel, data indicating a filter coefficient a_{D-2} of the second next pixel, and data indicating a filter coefficient a_{D-3} of the third next pixel.

The multiplier 163_1 reads the data indicating the filter coefficient a_{D+3} of the third preceding pixel from the filter coefficient storage part 162. The multiplier 163_1 multiplies the one-pixel delayed data supplied from the one-pixel delay element 161_1 by the data indicating the filter coefficient a_{D+3} of the third preceding pixel, and outputs data obtained through the multiplication to the adder 164.

Similarly, the multiplier 163_2 reads the data indicating the filter coefficient a_{D+2} of the second preceding pixel from the filter coefficient storage part 162. The multiplier 163_2 multiplies the two-pixel delayed data supplied from the one-pixel delay element 161_2 by the data indicating the filter coefficient a_{D+2} of the second preceding pixel, and outputs data obtained through the multiplication to the adder 164.

Similarly, the multiplier 163_3 reads the data indicating the filter coefficient a_{D+1} of the preceding pixel from the filter coefficient storage part 162. The multiplier 163_3 multiplies the three-pixel delayed data supplied from the one-pixel delay element 161_3 by the data indicating the filter coefficient a_{D+1} of the preceding pixel, and outputs data obtained through the multiplication to the adder 164.

Similarly, the multiplier 163_4 reads the data indicating the filter coefficient a_{D0} of the target pixel from the filter coefficient storage part 162. The multiplier 163_3 multiplies the four-pixel delayed data supplied from the one-pixel delay element 161_4 by the data indicating the filter coefficient a_{D0} of the target pixel, and outputs data obtained through the multiplication to the adder 164.

Similarly, the multiplier 163_5 reads the data indicating the filter coefficient a_{D-1} of the next pixel from the filter coefficient storage part 162. The multiplier 163_5 multiplies the five-pixel delayed data supplied from the one-pixel delay element 161_5 by the data indicating the filter coefficient a_{D-1} of the next pixel, and outputs data obtained through the multiplication to the adder 164.

Similarly, the multiplier 163_6 reads the data indicating the filter coefficient a_{D-2} of the second next pixel from the filter coefficient storage part 162. The multiplier 163_6 multiplies the six-pixel delayed data supplied from the one-pixel delay element 161_6 by the data indicating the filter coefficient a_{D-2} of the second next pixel, and outputs data obtained through the multiplication to the adder 164.

Similarly, the multiplier 163_7 reads the data indicating the filter coefficient a_{D-3} of the third next pixel from the filter coefficient storage part 162. The multiplier 163_7 multiplies the seven-pixel delayed data supplied from the one-pixel delay element 161_7 by the data indicating the filter coefficient a_{D-3} of the third next pixel, and outputs data obtained through the multiplication to the adder 164.

The adder 164 adds the data items supplied from the respective multipliers 163_{—}k together, and outputs image data obtained through the addition to the first nonlinear operator 170 as image data W_{HL} including a horizontal low frequency component.

The vertical low-pass filter 150_2 has the same circuit configuration as the vertical high-pass filter 150_2 and is different therefrom only in a filter coefficient, and thus description of a circuit configuration will be omitted.

Similarly, the horizontal high-pass filter 160_2 has the same circuit configuration as the horizontal low-pass filter 160 and is different therefrom only in a filter coefficient, and thus description of a circuit configuration will be omitted.

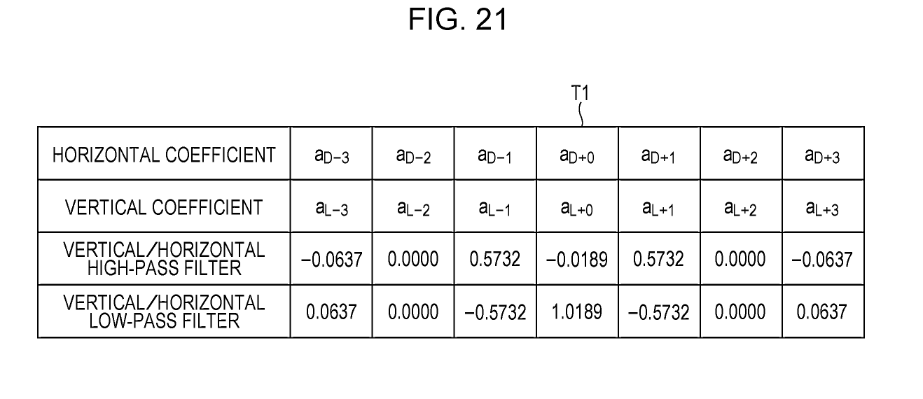

FIG. 21 is a table T1 illustrating an example of setting filter coefficients when seven lines are delayed in the vertical direction or seven pixels are delayed in the horizontal direction. FIG. 21 shows horizontal coefficients used when a filter is applied in the horizontal direction and vertical coefficients used when a filter is applied in the vertical direction. Here, coefficients of the vertical high-pass filter 150 and the horizontal high-pass filter 160_2 are the same as each other. In addition, coefficients of the vertical low-pass filter 150_2 and the horizontal low-pass filter 160 are the same as each other.

In FIG. 21, a sum value of the coefficients of seven filters in each row is 0.

The vertical signal extraction part 140 and the horizontal signal extraction part 140_2 include at least one high-pass filter, and a sum value of filter coefficients is required to be 0. In other words, a transfer function of a DC component of the high-pass filters included in the vertical signal extraction part 140 and the horizontal signal extraction part 140_2 is 0.

Successively, a process performed by the first nonlinear operator 170 will be described. In addition, a process performed by the second nonlinear operator 170_2 is the same as the process performed by the first nonlinear operator 170, and thus description thereof will be omitted.

When the image data W_{HL} including a horizontal low frequency component supplied from the horizontal low-pass filter 160 is reset to input data W, the first nonlinear operator 170 performs a nonlinear operation on the input data W according to the following Equation (1) so as to output the following signal N(W).

$$N ( W ) = sgn ( w ) {\sum }_{k = 1}^{K} {c}_{k} {\vert W \vert}^{k} \qquad ( 1 )$$

Here, sgn(W) is a function for recovering a sign of the argument W, ck is a nonlinear operation coefficient, k is an integer of 1 to K and is an index of a nonlinear operation coefficient, and K is the number of nonlinear operation coefficients. The function of the above Equation (1) is an odd function which has a property of N(W)=−N(−W).

The odd function may be expressed by a series of powers of odd numbers when Taylor expansion is performed, and thus the above Equation (1) may be expressed as in the following Equation (2).

$$N ( W ) = {\sum }_{k = 0}^{∞} {B}_{2 k + 1} {W}^{2 k + 1} \qquad ( 2 )$$

Here, B₂ₖ₊₁ indicates respective coefficients of powers of odd numbers. The first nonlinear operator 170 calculates the powers of odd numbers so as to generate odd-order harmonics. This is clear from a principle in which, if u=exp(jωX) is raised to a power of (2k+1), a component of the power of (2k+1) generates a (2k+1)-th order harmonic so that u(2k+1)=exp(jωX)(2k+1)=exp {j(2k+1)ωX}.

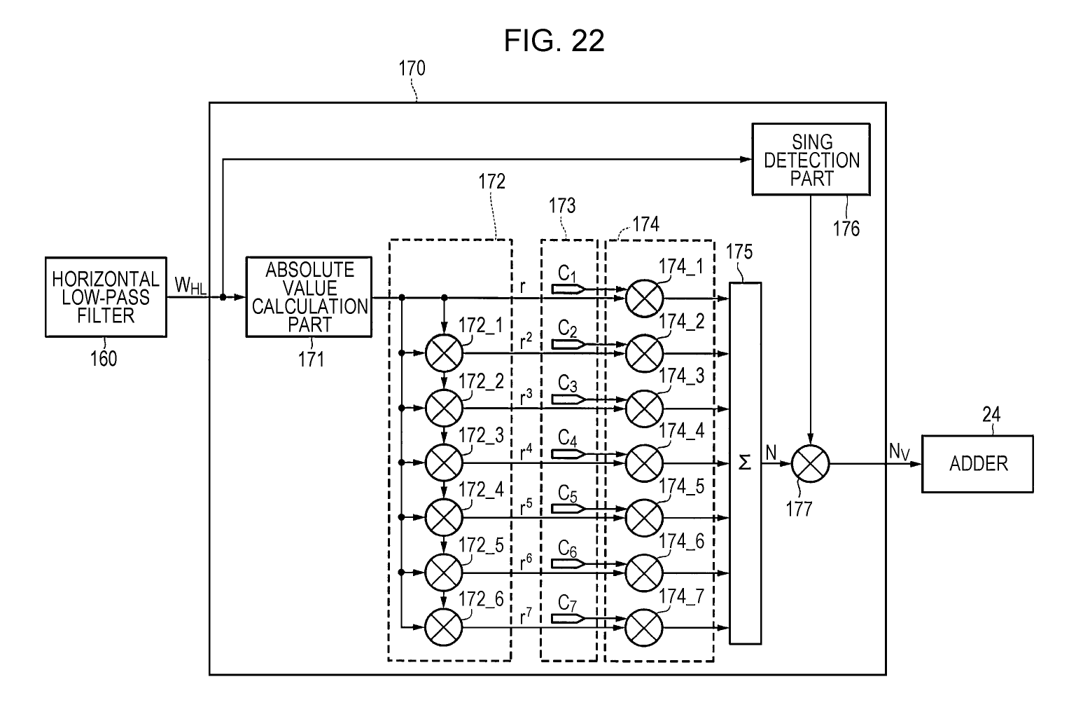

FIG. 22 is a functional block diagram of the first nonlinear operator 170 according to the second embodiment. The first nonlinear operator 170 includes an absolute value calculation part 171, a power operation part 172, a nonlinear operation coefficient storage part 173, a multiplying part 174, an adder 175, a sign detection part 176, and a multiplying part 177. Here, the power operation part 172 has six multipliers 172_{—}p (where p is an integer of 1 to 6) including multipliers 172_1 to 172_6. In addition, the multiplying part 174 has seven multipliers 174_{—}q (where q is an integer of 1 to 7) including multipliers 174_1 to 174_7.

The absolute value calculation part 171 calculates an absolute value of the image data W_{HL} including a horizontal low frequency component supplied from the horizontal low-pass filter 160, and outputs the calculated absolute value data r to the respective multipliers 172_{—}p of the power operation part 172 and the multiplier 174_1 of the multiplying part 174.

The multiplier 172_1 multiplies the absolute value data r supplied from the absolute value calculation part 171 by itself, and outputs squared data r² obtained through the multiplication to the multiplier 172_2 and the multiplier 174_2.

The multiplier 172_2 multiplies the absolute value data r supplied from the absolute value calculation part 171 by the squared data r² supplied from the multiplier 172_1, and outputs cubed data r³ obtained through the multiplication to the multiplier 172_3 and the multiplier 174_3.

Similarly, the multiplier 172_{—}p (where p is an integer of 3 to 5) multiplies the absolute value data r supplied from the absolute value calculation part 171 by the p-th power data r^{p} supplied from the multiplier 172_{—}p−1, and outputs (p+1)-th power data r^{p+1} obtained through the multiplication to the multiplier 172_{—}p+1 and the multiplier 174_{—}p+1.

Finally, the multiplier 172_6 multiplies the absolute value data r supplied from the absolute value calculation part 171 by the sixth power data r⁶ supplied from the multiplier 172_5, and outputs seventh power data r⁷ obtained through the multiplication to the multiplier 174_7.

The nonlinear operation coefficient storage part 173 stores data indicating seven nonlinear operation coefficients including nonlinear operation coefficients c₁ to c₇.

The multiplier 174_1 reads the data indicating the nonlinear operation coefficient c₁ from the nonlinear operation coefficient storage part 173. The multiplier 174_1 multiplies the absolute value data r supplied from the absolute value calculation part 171 by the operation coefficient c₁, and outputs data c₁r obtained through the multiplication to the adder 175.

Similarly, the multiplier 174_2 reads the nonlinear operation coefficient c₂ from the nonlinear operation coefficient storage part 173. The multiplier 174_2 multiplies the squared data r² supplied from the multiplier 172_1 by the nonlinear operation coefficient c₂, and outputs data c₂r² obtained through the multiplication to the adder 175.

Similarly, the multiplier 174_{—}q (where q is an integer of 3 to 7) reads the nonlinear operation coefficient c_{q} from the nonlinear operation coefficient storage part 173. The multiplier 174_{—}q multiplies the q-th power data r^{q} supplied from the multiplier 172_{—}q−1 by the nonlinear operation coefficient c_{q}, and outputs data c_{q}r^{q} obtained through the multiplication to the adder 175.

The adder 175 calculates a sum total N (=c₁r+c₂r²+c₃r³+c₄r⁴+c₅r⁵+c₆r⁶+c₇r⁷) of the data items supplied from the respective multipliers 174_{—}q (where q is an integer of 1 to 7), and outputs data indicating the calculated sum total N to the multiplying part 177.

The sign detection part 176 detects a sign of the image data W_{HL} including a horizontal low frequency component supplied from the horizontal low-pass filter 160. In addition, the sign detection part 176 outputs data indicating −1 to the multiplying part 177 when the detected sign is below 0, and outputs data indicating 1 to the multiplying part 177 when the detected sign is equal to or more than 0.

The multiplying part 177 multiplies the data indicating the sum total N supplied from the adder 175 by the data (the data indicating −1 or the data indicating 1) supplied from the sign detection part 176, and outputs data obtained through the multiplication to the adder 24 as data N_{V} for supplementing a vertical high frequency component.

In the second embodiment, the nonlinear operation coefficients of the first nonlinear operator 170 are set to c₂=1 and cₖ=0 (where k≠2) so that an operation in the first nonlinear operator 170 leads to N_{V}=sgn(W_{HL})|W_{HL}|². In addition, only the multiplier 172_1 is used as a multiplier of the power operation part 172, and only the two of multiplier 174_1 and multiplier 174_2 are used as multipliers of the multiplying part 174. As a result, it is possible to generate a third-order harmonic with a smaller number of multipliers than in a case where the nonlinear operation coefficients of the first nonlinear operator 170 are set to c₃=1 and cₖ=0 (where k≠3), and thus it is possible to reduce a circuit scale.

In addition, in order to generate a third-order harmonic in the same manner as in the second embodiment, the nonlinear operation coefficients of the first nonlinear operator 170 may be set to c₃=1 and cₖ=0 (where k≠3). In this case, only the two of multiplier 172_1 and multiplier 172_2 are used as multipliers of the power operation part 172, and only the three of multiplier 174_1, multiplier 174_2 and multiplier 174_3 are used as multipliers of the multiplying part 174.

The second nonlinear operator 170_2 has the same configuration as the first nonlinear operator 170, and thus description thereof will be omitted.

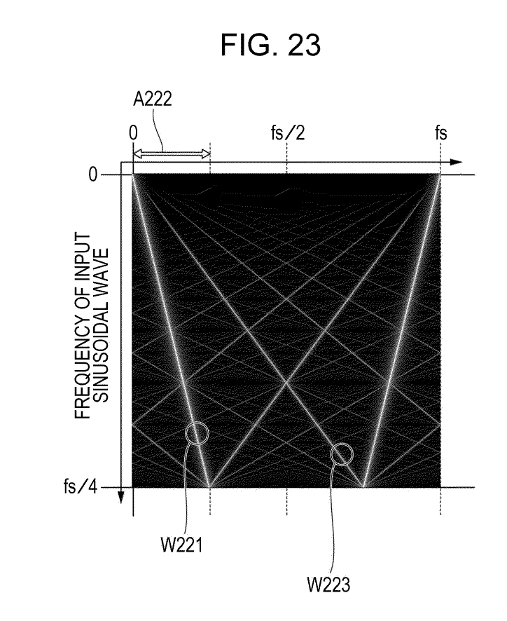

FIG. 23 is a diagram illustrating an example of a signal intensity distribution of an output signal which is output from the first nonlinear operator 170. FIG. 23 shows a signal intensity distribution of an output signal which is output from the first nonlinear operator 170 in a case where a frequency of a sinusoidal input signal which is input to the first nonlinear operator 170 is made to sweep from 0 [Hz] to fs/4 [Hz] (where fs is a sampling frequency). Here, an operation in the first nonlinear operator 170 satisfies N_{V}=sgn(W_{HL})|W_{HL}|².

In FIG. 23, the longitudinal axis expresses a frequency of a sinusoidal input signal which is input to the signal supplementing section 23b, and the transverse axis expresses a frequency of an output signal which is output from the signal supplementing section 23b. In addition, the light and shade at each point indicates a signal intensity at a frequency of the output signal which is output from the signal supplementing section 23b with respect to a frequency of the input signal. Here, the signal intensity at each point is an absolute value of a value obtained by performing fast Fourier transform (FFT) on the output signal.

In FIG. 23, an upper limit band of the input signal is indicated by the arrow A222. In addition, the white parts indicate a frequency band including a signal output from the signal supplementing section 23b. The white parts include a signal intensity distribution W221 of the input signal and a signal intensity distribution W223 of a third higher harmonic which is a third higher harmonic signal of the input signal. In other words, the signal output from the signal supplementing section 23b includes the input signal and the third higher harmonic signal of the input signal.

In addition, in FIG. 23, high frequency signals which are five or more times as high as the input signal are further included, and the input signal and signals in which third or more odd-order harmonic signals are folded back at a half frequency (fs/2) of the sampling frequency are included.

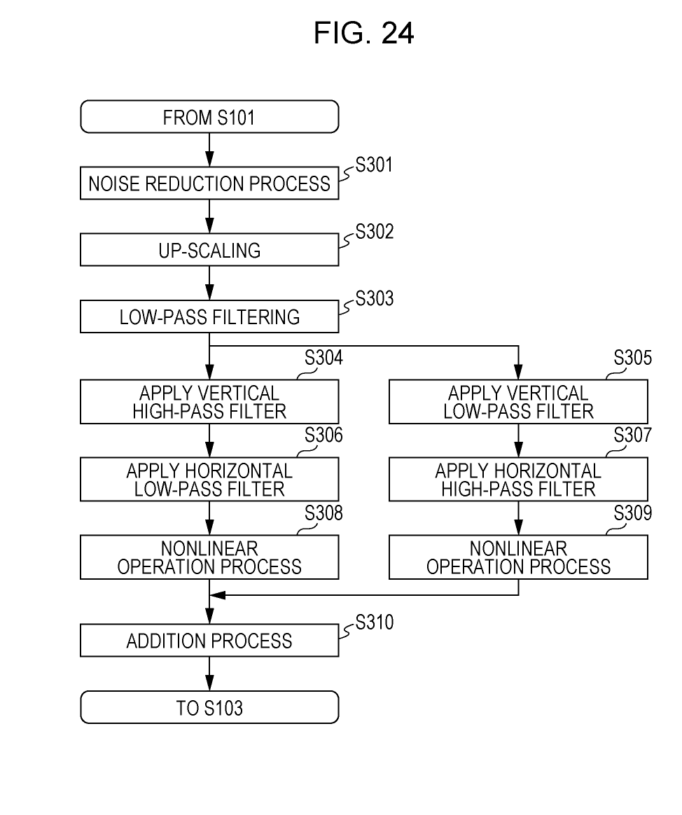

An image processing operation in the display device 1b according to the second embodiment is the same as in FIG. 14, and thus description thereof will be omitted. FIG. 24 is a flowchart illustrating a flow of processes performed by the image processing unit 20b according to the second embodiment in step S102 of FIG. 14.

The processes from step S301 to S303 are the same as the processes from step S201 to S203, and description thereof will be omitted.

Next, the vertical high-pass filter 150 makes a signal of a frequency region higher than a predetermined frequency in the vertical direction pass therethrough with respect to the scale-converted image data (step S304).

In addition, the vertical low-pass filter 150_2 makes a signal of a frequency region lower than the predetermined frequency in the vertical direction pass therethrough with respect to the scale-converted image data (step S305).

Next, the horizontal low-pass filter 160 makes a signal of a frequency lower than a predetermined frequency in the horizontal direction pass therethrough with respect to the signal output from the vertical high-pass filter 150 (step S306).

In addition, the horizontal high-pass filter 160_2 makes a signal of a frequency higher than the predetermined frequency in the horizontal direction pass therethrough with respect to the signal output from the vertical low-pass filter 150_2 (step S307).

Next, the first nonlinear operator 170 performs nonlinear mapping on the signal output from the horizontal low-pass filter 160 (step S308). In addition, the second nonlinear operator 170_2 performs nonlinear mapping which uses the signal output from the horizontal high-pass filter 160_2 as an argument (step S309).

The adder 24 adds the data N_{V} for supplementing a vertical high frequency component output from the first nonlinear operator 170 and the data N_{H} for supplementing a horizontal high frequency component output from the second nonlinear operator 170_2 to the scale-converted image data (step S310). Therefore, the processes of the flowchart of FIG. 24 end.

The image processing unit 20b according to the second embodiment extracts a high frequency component in the horizontal direction from the scale-converted image data, and performs nonlinear mapping on the extracted horizontal direction high frequency component. In addition, the image processing unit 20b extracts a high frequency component in the vertical direction from the scale-converted image data, and performs nonlinear mapping on the extracted vertical direction high frequency component. Further, the image processing unit 20b adds signals obtained through the above-described two nonlinear mappings to the scale-converted image data.

Accordingly, the image processing unit 20b can supplement the scale-converted image data with data based on the high frequency component in the horizontal direction and data based on the high frequency component in the vertical direction. Therefore, it is possible to supplement a frequency region in which there is almost no signal with a signal, through the scale conversion. As a result, the image processing unit 20b can generate a defined image.

In addition, in the second embodiment, a description has been made of a case where the vertical signal extraction part 140 includes the vertical high-pass filter 150 and the horizontal low-pass filter 160, but the vertical signal extraction part 140 is not limited thereto and may include at least the vertical high-pass filter 150. Accordingly, the vertical signal extraction part 140 can extract data with a frequency component higher than a predetermined frequency in the vertical direction from the scale-converted image data.

In addition, in the second embodiment, a description has been made of a case where the horizontal signal extraction part 140_2 includes the vertical low-pass filter 150_2 and the horizontal high-pass filter 160_2, but the horizontal signal extraction part 140_2 is not limited thereto and may include at least the horizontal high-pass filter 160_2. Accordingly, the horizontal signal extraction part 140_2 can extract data with a frequency component higher than a predetermined frequency in the horizontal direction from the scale-converted image data.

### Modification Example of Second Embodiment

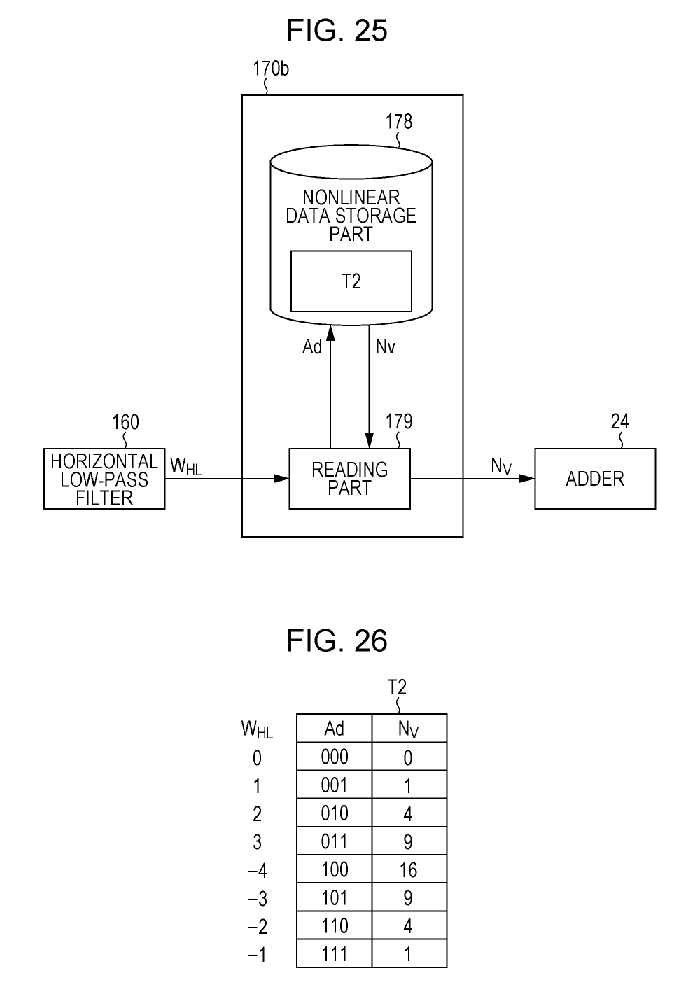

Next, a modification example of the first nonlinear operator 170 will be described with reference to FIG. 25. In addition, a process performed by a second nonlinear operator 170_2b according to the modification example of the second embodiment is the same as a process performed by a first nonlinear operator 170b, and thus description thereof will be omitted.

FIG. 25 is a block configuration diagram of the first nonlinear operator 170b according to the modification example of the second embodiment. The first nonlinear operator 170b includes a nonlinear data storage part 178 and a reading part 179.

The nonlinear data storage part 178 stores an address Ad corresponding to a value of the image data W_{HL} including a horizontal low frequency component and the data N_{V} for supplementing a vertical high frequency component in correlation with each other.

FIG. 26 shows an example of a table stored in the nonlinear data storage part 178 in the modification example of the second embodiment. In the table T2 of FIG. 26, the address Ad in which a value of the image data W_{HL} including a horizontal low frequency component is expressed in 3 bits is correlated with the data N_{V} for supplementing a vertical high frequency component. In FIG. 26, a value of the data N_{V} is a square of the data W_{HL}. In FIG. 26, the address Ad is expressed in 3 bits, and, when the data W_{HL} is 0, the address Ad is 000, and the data N_{V} in this case is 0 which is a square of the data W_{HL}.

Similarly, when the data W_{HL} is 1, the address Ad is 001, and the data N_{V} is 1 which is a square of the data W_{HL}. When the data W_{HL} is 2, the address Ad is 010, and the data N_{V} is 4 which is a square of the data W_{HL}. When the data W_{HL} is 3, the address Ad is 011, and the data N_{V} is 9 which is a square of the data W. When the data W_{HL} is −4, the address Ad is 100, and the data N_{V} is 16 which is a square of the data W. When the data W_{HL} is −3, the address Ad is 101, and the data N_{V} is 9 which is a square of the data W_{HL}. When the data W_{HL} is −2, the address Ad is 110, and the data N_{V} is 4 which is a square of the data W_{HL}. When the data W_{HL} is −1, the address Ad is 111, and the data N_{V} is 1 which is a square of the data W_{HL}.

Referring to FIG. 25 again, the reading part 179 reads, for example, the data N_{V} for supplementing a vertical high frequency component, correlated with the address Ad by using a bit string in which a value of the image data W_{HL} including a horizontal low frequency component supplied from the horizontal low-pass filter 160 is expressed in 3 bits as the address Ad, from the nonlinear data storage part 178. The reading part 179 outputs the read data N_{V} for supplementing a vertical high frequency component to the adder 24.

Accordingly, the first nonlinear operator 170b according to the modification example of the second embodiment reads the data N_{V} for supplementing a vertical high frequency component, correlated with the image data W_{HL} including a horizontal low frequency component. Therefore, the nonlinear operator 170b can generate the data N_{V} for supplementing a vertical high frequency component, and thus can reduce a calculation amount more than the first nonlinear operator 170 according to the second embodiment.

### Third Embodiment

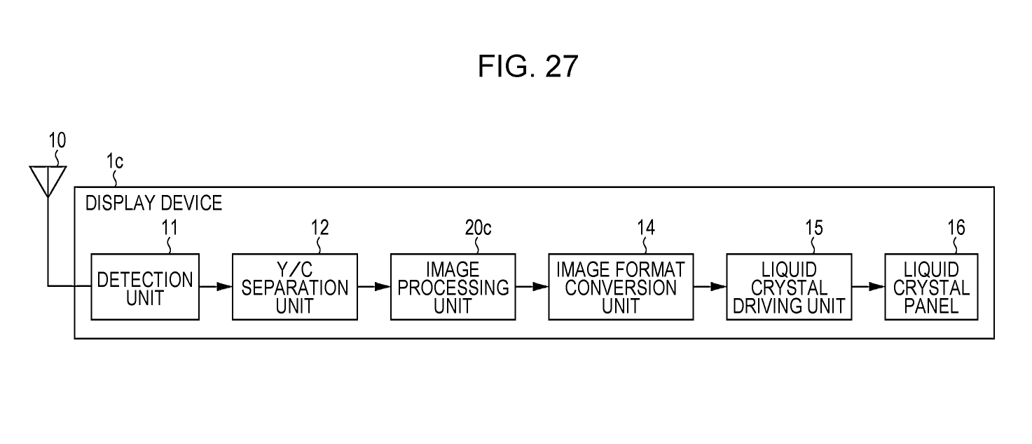

FIG. 27 is a schematic block diagram of a display device 1c according to a third embodiment. In addition, a constituent element common to the display device 1 according to the first embodiment of FIG. 1 is given the same reference numeral, and detailed description thereof will be omitted.

In a configuration of the display device 1c of FIG. 27, the image processing unit 20 in the configuration of the display device 1 of FIG. 1 is replaced with an image processing unit 20c.

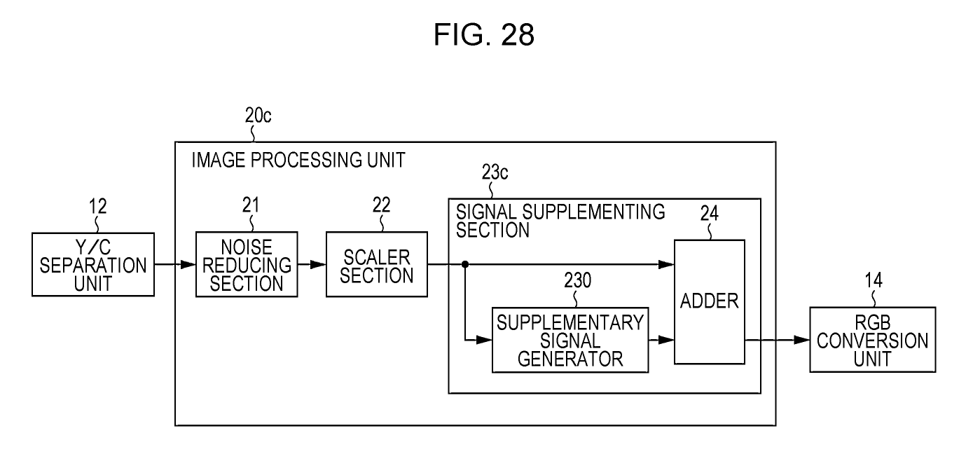

Successively, the image processing unit 20c will be described. FIG. 28 is a schematic block diagram of the image processing unit 20c according to the third embodiment. In addition, a constituent element common to the image processing unit 20 according to the first embodiment of FIG. 3 is given the same reference numeral, and detailed description thereof will be omitted.

In a configuration of the image processing unit 20c of FIG. 28, the signal supplementing section 23 in the configuration of the image processing unit 20 of FIG. 3 is replaced with a signal supplementing section 23c. In addition, in a configuration of the signal supplementing section 23c of FIG. 28, the supplementary signal generator 30 in the configuration of the signal supplementing section 23 of FIG. 3 is replaced with a supplementary signal generator 230.

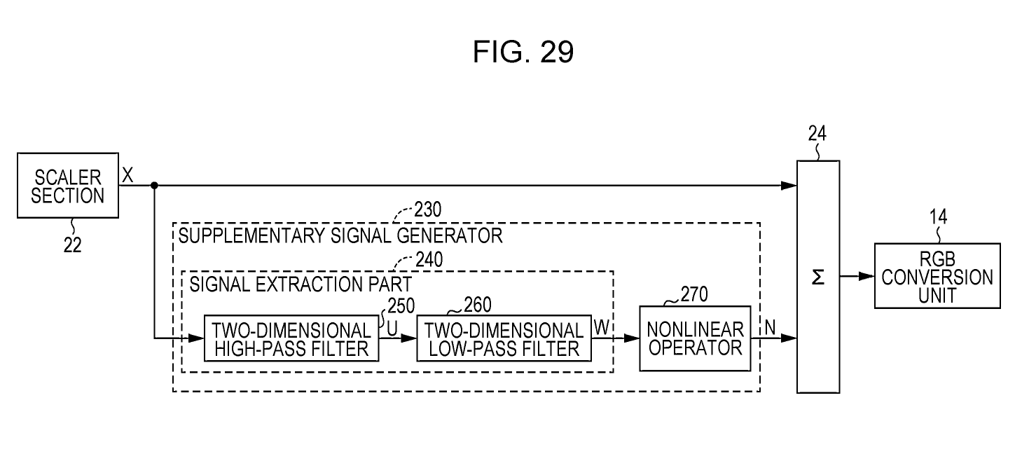

Next, the supplementary signal generator 230 will be described with reference to FIG. 29. FIG. 29 is a functional block diagram of the supplementary signal generator 230 according to the third embodiment. The supplementary signal generator 230 includes a signal extraction part 240 and a nonlinear operator 270. Here, the signal extraction part 240 includes a two-dimensional high-pass filter 250 and a two-dimensional low-pass filter 260.

The two-dimensional high-pass filter 250 makes a signal with a frequency higher than a first predetermined frequency f1 in a two-dimensional direction from the scale-converted image data X supplied from the scaler section 22 pass therethrough so as to generate image data U with a high frequency component, and outputs the image data U with a high frequency component to the two-dimensional low-pass filter 260.

The two-dimensional low-pass filter 260 makes a signal with a frequency lower than a second predetermined frequency f2 (where f2>f1) in the two-dimensional direction pass therethrough with respect to the image data U with a high frequency component supplied from the two-dimensional high-pass filter 250. Accordingly, the two-dimensional low-pass filter 260 generates image data W with a predetermined frequency band (f1 to f2), and outputs the generated image data W with the predetermined frequency band to the nonlinear operator 270.

Therefore, the two-dimensional low-pass filter 260 limits a frequency band of the output signal to a band of a signal with the predetermined frequency. For this reason, the two-dimensional low-pass filter 260 can prevent aliasing from causing failures in a flow frequency region when harmonics are generated in the subsequent nonlinear operator 270.

The nonlinear operator 270 performs nonlinear mapping (for example, odd function mapping) on the image data W with the predetermined frequency band supplied from the two-dimensional low-pass filter 260 in the same manner as the first nonlinear operator 270 according to the second embodiment, and outputs data N obtained through the nonlinear mapping to the adder 24.

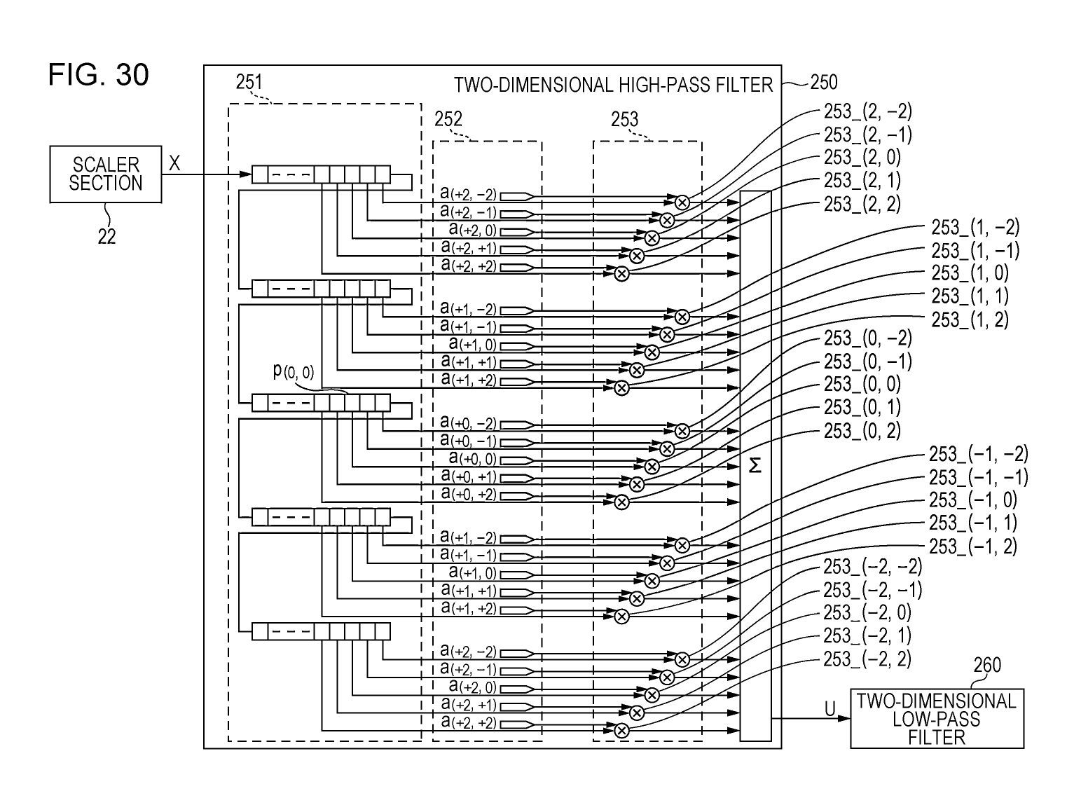

Next, details of the process performed by the two-dimensional high-pass filter 250 will be described with reference to FIG. 30. FIG. 30 is a functional block diagram of the two-dimensional high-pass filter 250 according to the third embodiment. The two-dimensional high-pass filter 250 includes a vertical pixel reference delay part 251, a filter coefficient storage part 252, a multiplying part 253, and an adder 254. Here, the multiplying part 253 has twenty-five multipliers 253_(v,h) including multipliers 253_(−2,−2) to 253_(2,2).

In the two-dimensional high-pass filter 250, the vertical pixel reference delay part 251 delays the scale-converted image data X supplied from the scaler section 251 by a predetermined number of pixels, and outputs the delayed data to the multiplying part 253.

In FIG. 30, with respect to image data P(0,0) of a target pixel which is a target to which the two-dimensional high-pass filter is applied, data of a pixel which is shifted vertically upward by v rows from the target pixel and is then shifted horizontally to the left by h columns is set as image data P(v,h).

Here, if the number of horizontal synchronization signals is set to Ns, and a delay amount which is given to the image data P(0,0) of the target pixel is set to D, a delay amount given to the image data P(v,h) becomes D−v×Ns−h.

For example, the vertical pixel reference delay part 251 outputs image data items delayed by giving the delay amount of D−v×Ns−h to image data items P(v,h) included in the scale-converted image data X, to the multipliers 253_(v,h) of the multiplying part 253, respectively.

The filter storage part 252 stores information indicating a filter coefficient a(v,h) (here, as an example, v is an integer of −2 to 2, and h is an integer of −2 to 2).

The multiplier 253_(v,h) reads the information indicating the filter coefficient a(v,h) from the filter coefficient storage part 252. The multiplier 253_(v,h) multiplies the data which is delayed by a predetermined number of pixels and is supplied from the two-dimensional high-pass filter 250, by the filter coefficient a(v,h), and outputs data obtained through the multiplication to the adder 254.

The adder 254 adds the data items supplied from the respective multipliers 253_(v,h) together, and outputs image data obtained through the addition to the two-dimensional low-pass filter 260 as image data U with a high frequency component.

In addition, the two-dimensional low-pass filter 260 has the same circuit configuration as the two-dimensional high-pass filter 250 and is different therefrom only in a filter coefficient stored in the filter coefficient storage part 252, and thus detailed description thereof will be omitted.

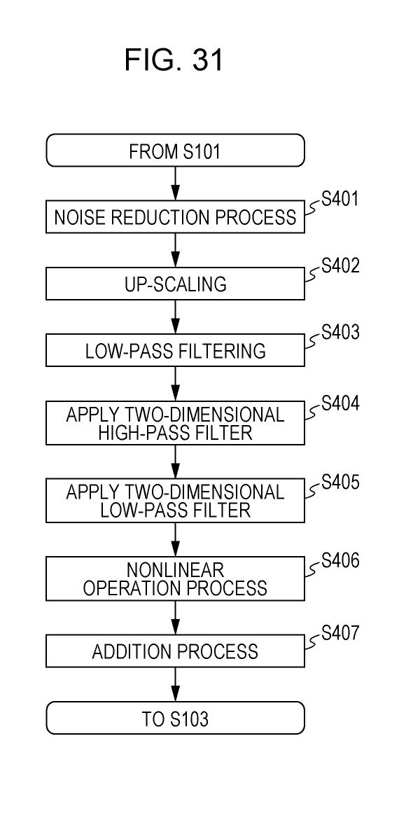

An image processing operation in the display device 1c according to the third embodiment is the same as in FIG. 14, and thus description thereof will be omitted. FIG. 31 is a flowchart illustrating a flow of processes performed by the image processing unit 20c according to the third embodiment in step S102 of FIG. 14.

The processes from step S401 to S403 are the same as the processes from step S201 to S203, and description thereof will be omitted.

Next, the two-dimensional high-pass filter 250 makes a signal of a frequency region higher than the predetermined frequency f1 in the two-dimensional direction pass therethrough with respect to the scale-converted image data (step S404).

Next, the two-dimensional low-pass filter 260 makes a signal with a frequency lower than the second predetermined frequency f2 (where f2>f1) in the two-dimensional direction pass therethrough with respect to the image data U with a high frequency component supplied from the two-dimensional high-pass filter 250 (step S405).

The nonlinear operator 270 performs nonlinear mapping on the image data W with the predetermined frequency band supplied from the two-dimensional low-pass filter 260 (step S406).

Next, the adder 24 adds data N which is obtained through the nonlinear mapping and is supplied from the nonlinear operator 270 to the scale-converted image data (step S407). Therefore, the processes of the flowchart of FIG. 31 end.

As described above, the image processing unit 20c according to the third embodiment extracts a high frequency component in the two-dimensional direction from the scale-converted image data, and performs the nonlinear mapping on the extracted high frequency component in the two-dimensional direction. In addition, the image processing unit 20c adds a signal obtained through the nonlinear mapping to the scale-converted image data.

Accordingly, since the image processing unit 20c can supplement the scale-converted image data with data based on the high frequency component in the two-dimensional direction, it is possible to supplement a frequency region in which there is almost no signal with a signal, through the scale conversion. As a result, the image processing unit 20c can generate a defined image.

In addition, in the third embodiment, the signal extraction part 240 includes the two-dimensional high-pass filter 250 and the two-dimensional low-pass filter 260 but is not limited thereto, and the signal extraction part 240 may include at least the two-dimensional high-pass filter 250. Accordingly, the signal extraction part 240 can extract data with a frequency component higher than a predetermined frequency on a two-dimensional plane from the scale-converted image data.

As above, in common to the embodiments of the present invention, the display device (1, 1b, or 1c) in each embodiment reduces noise of an image, and generates a scale-converted image obtained by scaling up the noise-reduced image. The display device (1, 1b, or 1c) extracts a signal of a frequency band reduced due to the noise reduction in each pixel of the scale-converted image, and performs nonlinear mapping on the extracted signal of the frequency band.

In addition, the display device (1, 1b, or 1c) adds a nonlinear mapping-resultant pixel value to a pixel value of the scale-converted image corresponding to a position of the pixel value, so as to correct the image having undergone the noise reduction process. Accordingly, the display device (1, 1b, or 1c) can generate a defined image by supplementing a frequency band in which there is almost no signal with a signal.

In addition, since a plurality of low resolution images are required to be used in the method of PTL 2, a frame memory is required to be used, and thus a circuit scale is large. However, the image processing units (20, 20b, and 20c) in all the embodiments are not required to use a frame memory, and thus there is an advantage in that a circuit scale is small.

Further, in the method of PTL 2, repetitive operations are required to be performed in order to calculate a weight, but the image processing units (20, 20b, and 20c) in all the embodiments have an advantage in that repetitive operations are not required to be performed.

In addition, in common to all the embodiments, the image processing units (20, 20b, and 20c) have been described as a configuration of including the scaler section 22, but the scaler section 22 may be omitted in a case where up-scaling is not necessary. In this case, the image processing units (20, 20b, and 20c) may supply noise-reduced image data which is output from the noise reducing section 21, to the signal supplementing section 23.

Accordingly, the image processing units (20, 20b, and 20c) can supplement the noise-reduced image data with data based on a high frequency component included in image data, and thus it is possible to supplement the noise-reduced image data with the high frequency component reduced due to the noise reduction by the noise reducing section 21. As a result, the image processing units (20, 20b, and 20c) can generate a defined image.

Further, in common to all the embodiments, a description has been made of a case where the signal supplementing sections (23, 23b, and 23c) supplement the image signal with a signal obtained by performing nonlinear mapping (for example, odd function mapping) on a signal with a predetermined frequency band in an input image signal, but the present invention is not limited thereto. The signal supplementing sections (23, 23b, and 23c) may generate a harmonic signal of a signal with a predetermined frequency band in an input image signal, and may supplement the image signal with the generated harmonic signal.

In addition, although a description has been made of a case where the image processing units (20, 20b, and 20c) in all the embodiments are realized as a portion of the display devices (1, 1b, and 1c), the present invention is not limited thereto, and the image processing units (20, 20b, and 20c) may be realized as image processing devices.

In addition, a program for executing processes of each of the image processing units (20, 20b, and 20c) in the embodiments may be recorded on a computer readable recording medium, and the program recorded on the recording medium may be read to a computer system so as to be executed, thereby performing the above-described various processes related to the image processing units (20, 20b, and 20c).

Further, the “computer system” described here may be one including an OS or hardware such as a peripheral device. Furthermore, the “computer system” is assumed to also include home page providing circumstances (or display circumstances) if the WWW system is used. Moreover, the “computer readable recording medium” refers to a flexible disk, a magneto-optical disc, a ROM, a writable nonvolatile memory such as a flash memory, a portable medium such as a CD-ROM, or a storage device such as a hard disk built in the computer system.

In addition, the “computer readable recording medium” also includes one which holds a program for a specific time such as a nonvolatile memory (dynamic random access memory (DRAM)) of the computer system, which becomes a server or a client when the program is transmitted via a network such as the Internet or a communication line such as a telephone line. Further, the program may be transmitted from a computer system in which the program is stored in a storage device or the like to other computer systems via a transmission medium, or using a transmission wave in the transmission medium. Here, the “transmission medium” which transmits the program refers to a medium having a function of transmitting information, including a network (communication network) such as the Internet or a communication line such as a telephone line. Furthermore, the program may be used to realize some of the above-described functions. Moreover, the program may be a so-called differential file (differential program) which can realize the above-described functions in combination with a program which has already been recorded in a computer system.

As above, although the embodiments of the present invention have been described in detail with reference to the drawings, a specific configuration is not limited to the embodiments, and includes a design and the like within the scope without departing from the spirit of the present invention.

### DESCRIPTION OF REFERENCE NUMERALS

1, 1b, 1c Display device
10 Antenna
11 Detection unit
12 Y/C separation unit
20 Image processing unit
14 Image format conversion unit
15 Liquid crystal driving unit
16 Liquid crystal panel
20, 20b, 20c Image processing unit
21 Noise reducing section
21_1 Delay portion
21_2 Signal selection portion
21_3 Voltage comparison portion
21_4 Noise level detection portion
21_5 Signal output portion
22 Scaler section
23, 23b, 23c Signal supplementing section
24 Adder
30 Supplementary signal generator
30_1 to 30_M Nonlinear mapping portion
40_1 to 40_M Filter
50_1,1 to 50_M,N Linear filter
70_1 to 70M Nonlinear operator
130 Supplementary signal generator
130_1 Vertical nonlinear mapping portion
130_2 Horizontal nonlinear mapping portion
140 Vertical signal extraction part
140_2 Horizontal signal extraction part
150 Vertical high-pass filter
150_2 Vertical low-pass filter
151 Vertical pixel reference delay part
152 Filter coefficient storage part
153 Multiplying part
154 Adder
160 Horizontal low-pass filter
160_2 Horizontal high-pass filter
161 Horizontal pixel reference delay part
162 Filter coefficient storage part
163 Multiplying part
164 Adder
170 First nonlinear operator
170_2 Second nonlinear operator
171 Absolute value calculation part
172 Power operator
172_1 to 172_6 Multiplier
173 Nonlinear operation coefficient storage part
174 Multiplying part
174_1 to 172_7 Multiplier
175 Adder
176 Sign detection part
177 Multiplying part
178 Nonlinear data storage part
179 Reading part
230 Supplementary signal generator
240 Signal extraction part
250 Two-dimensional high-pass filter
251 Vertical pixel reference delay part
252 Filter coefficient storage part
253 Multiplying part
254 Adder
260 Two-dimensional low-pass filter
270 Nonlinear operator

1-13. (canceled)

14. An image processing device comprising:
a noise reducing unit that reduces noise of an image signal;
a signal supplementing unit that generates a harmonic signal of a signal with a predetermined frequency band in the noise-reduced image signal, and supplements the noise-reduced image signal with the generated harmonic signal.

15. The image processing device according to claim 14, wherein the signal supplementing unit performs nonlinear mapping on the signal with the predetermined frequency band so as to generate the harmonic signal.

16. The image processing device according to claim 15, wherein the nonlinear mapping is odd function mapping.

17. The image processing device according to claim 14, wherein the predetermined frequency band is a frequency higher than a predetermined frequency in the image signal.

18. The image processing device according to claim 14, wherein the signal supplementing unit includes:
a supplementary signal generating section that performs nonlinear mapping on the signal with the predetermined frequency band in the image signal; and
an adder that adds a signal obtained by the supplementary signal generating section performing the nonlinear mapping to the image signal.

19. The image processing device according to claim 18, wherein the supplementary signal generating section includes:
a filter that applies a linear filter to the image signal; and
a nonlinear operator that performs nonlinear mapping on a signal obtained by the filter applying the linear filter, and
wherein the adder adds a signal obtained by the nonlinear operator performing the nonlinear mapping to the image signal.

20. The image processing device according to claim 19, wherein the filter includes:
a vertical high-pass filter that makes a frequency component higher than a predetermined frequency in a vertical direction pass therethrough with respect to the image signal; and
a horizontal high-pass filter that makes a frequency component higher than a predetermined frequency in a horizontal direction pass therethrough with respect to the image signal,
wherein the nonlinear operator generates a signal which is obtained by performing nonlinear mapping on the signal having passed through the vertical high-pass filter and supplements the image signal with a vertical high frequency component, and generates a signal which is obtained by performing a nonlinear mapping on the signal having passed through the horizontal high-pass filter and supplements the image signal with a horizontal high frequency component, and
wherein the adder the signal which supplements the image signal with the vertical high frequency component and the signal which supplements the horizontal high frequency component.

21. The image processing device according to claim 19, wherein the filter includes a two-dimensional high-pass filter that makes a frequency component higher than a predetermined frequency in a two-dimensional direction pass therethrough with respect to the image signal,
wherein the nonlinear operator performs nonlinear mapping on the signal having passed through the two-dimensional high-pass filter, and
wherein the adder adds a signal obtained by the nonlinear operator performing the nonlinear mapping to the image signal.

22. The image processing device according to claim 14, further comprising a scaler unit that performs scale conversion on the image signal to obtain an image with a number of pixels larger than the number of pixels obtained from the image signal,
wherein the signal supplementing unit generates a harmonic signal of a signal with a predetermined frequency band in an image signal which has been scale-converted by the scaler unit, and supplements the scale-converted image signal with the generated harmonic signal.

23. A display apparatus comprising:
an image processing device including
a noise reducing unit that reduces noise of an image signal; and
a signal supplementing unit that generates a harmonic signal of a signal with a predetermined frequency band in the noise-reduced image signal, and supplements the noise-reduced image signal with the generated harmonic signal.

24. An image processing method comprising:
a step of reducing noise of an image signal; and
a step of generating a harmonic signal of a signal with a predetermined frequency band in the noise-reduced image signal, and supplementing the noise-reduced image signal with the generated harmonic signal.
